(19) United States
(12) Patent Application Publication
(10) Pub. No.: US 2009/0044216 A1
(43) Pub. Date: Feb. 12, 2009

(54) Internet-Based System for Interactive Synchronized Shared Viewing of Video Content

(76) Inventor: Marcel McNicoll, Silver Spring, MD (US)

Correspondence Address: EPSTEIN & GERKEN, 1901 RESEARCH BOULEVARD, SUITE 340, ROCKVILLE, MD, 20850, US

(21) Appl. No.: 12/188,303

(22) Filed: Aug. 8, 2008

Related U.S. Application Data
(60) Provisional application No. 60/963,967, filed on Aug. 8, 2007.

(51) Int. Cl. H04N 7/16; H04N 7/173; H04N 7/025

(52) U.S. Cl. 725/5; 725/87; 725/34; 725/1

(57) ABSTRACT

Internet-based viewing system for interactive synchronized shared viewing of video content comprises a website accessible to customers of the viewing system and providing mechanisms for the customers to select, author and schedule viewing sessions for transmission by the system, to invite other customers to view selected viewing sessions in synchronicity as a shared viewing group while allowing interactive communication between the customers within the viewing group. The system website provides mechanisms for providers of video content and customers to author viewing programs and makes them available to customers on the system website. Advertisements and/or interactive components may be included in the viewing programs as part of the authoring processes.

### CROSS-REFERENCE TO RELATED PATENT APPLICATION

This application claims priority from prior U.S. provisional patent application Ser. No. 60/963,967 filed Aug. 8, 2007, the entire disclosure of which is incorporated herein by reference.

### BACKGROUND OF THE INVENTION

1. Field of the Invention

The present invention pertains generally to systems for implementing synchronized shared viewing of video content among a group of viewers while allowing various forms of interaction between the viewers. More particularly, the present invention pertains to a system for interactive synchronized shared viewing of video content via the Internet that provides a wide range of options for customization of video programming and advertisement content by viewers and other users of the system through a collaborative and community based effort.

2. Brief Discussion of the Related Art

Viewing systems have been generally proposed for delivering video content to a group of viewers while allowing the viewers to communicate with one another during the viewing experience as represented by U.S. Patent Application Publications No. US 2005/0015809 A1 to Boys, No. US 2006/0242303 A1 to Petrack, and No. US 2007/0050822 A1 to Stevens et al. However, many viewing systems thus far proposed for implementing an interactive shared viewing experience among a group of viewers are limited from a practical standpoint to television applications and, in particular, to cable television applications. Federal and local laws pertaining to television and cable transmission of video content contain restrictions and standards that make interactive shared viewing systems for the television and cable environment practically inapplicable to a comprehensive Internet-based application. Moreover, interactive shared viewing systems thus far proposed are limited in features, flexibility, geographic and providers' boundaries, and the extent to which the viewing systems are able to incorporate viewer customizations and preferences of viewers and other users of the systems.

Various modalities and systems have been proposed for the delivery of video content via the Internet. One modality, known as IP Multicast, emerged around the mid-1990s and was proposed as a model to replicate the TV broadcasting experience at a time when user bandwidth was scarce. Basically, a server created a program of video content and published scheduling information for the program on an Internet website. Viewers could then access the Internet at the scheduled time and watch the same program at the same time. IP Multicast met with only limited acceptance due to the complexity and burdensome nature of the required networking infrastructure and due to its lack of practicality in the face of continually increasing user bandwidth connectivity. Another modality, known as streaming video, is now commonly used for the delivery of video content via the Internet. Although the video quality is typically poor compared to standard TV-DVD video quality, streaming video allows viewers to control when, where and what video content they watch. A viewer is able to begin viewing the video content almost instantaneously, after some minor “buffering” delays. The approach is highly individualistic, however, in that each viewer's viewing experience is completely asynchronous to the viewing experiences of other viewers. Streaming video is usually applied to free/promotional video material. An additional modality for the delivery of video content via the Internet involves video downloads with an embedded DRM control mechanism. Typically, a viewer orders video content from a server, which sends the complete file for the video content to the viewer with an embedded DRM control mechanism that permits the video content to be played only from the computer from which the video content was ordered. The viewer is able to begin playing the video content only after the file is completely downloaded, which could take an appreciable length of time.

An internet-based service that enables users to watch videos together while simultaneously “chatting” over the Internet has been made available under the name of SeeToo. A user of the system is able to send their own video, created using a camcorder, digital camera or cellular phone, for example, from their own computer to the computers of other users. The user sending the video sends a link to the video to the other users in email or instant messaging. The system utilizes the sending user's computer to stream the video in real time to the computers of the other users using P2P-type technology.

Another Internet-based service that allows for real time, shared and interactive viewing of video has been commercialized under the name of Gaia Online. Gaia Online is essentially a social networking and forums-based website, primarily focused on gaming, that offers a component called Gaia Cinemas through which customers can watch video together in a virtual theater while being able to instant message one another. Customers do not have the option of inviting specific other customers to participate in the virtual theater and, once the video begins to play, interaction between viewing customers is essentially limited to instant messaging. A feature of Gaia Online, called Gaia VJ, allows customers to create playlists of video from video-hosting sites, such as YouTube, but the playlists have no role in the video shown in the virtual theaters. The Gaia Online system incorporates a feature called Gaia Quest that grants customers items in exchange for performing certain tasks specified by the system.

Recently, Microsoft Corporation has announced the availability in various countries of “Messenger TV”, a video sharing service that uses Windows Live Messenger to view MSN videos in parallel, although not in a real-time synchronous manner, with customers who are already in live message communication with each other over the Internet.

### SUMMARY OF THE INVENTION

As used herein, “play list” means a collection of content items which constitute the foundation of a viewing program that will be viewed by customers in a sequential order during a shared viewing event; a “shared viewing program” means a content play list associated with a set of business rules and processes for handling placeholders, fees, viewing duration and advertisement credits; “viewing session” means the situation where a viewing program is scheduled and a list of invitees is set and where a placeholder is switched to a dynamic video asset and the fee confirmation is processed; “shared viewing event (BuddyCast)” means a viewing session transmitted to users assembled in a shared viewing group and consumed.

The present invention is generally characterized in an Internet-based viewing system for interactive synchronized shared viewing of video content comprising a viewing system website accessible to viewing customers of the viewing system via the Internet. The system website provides a program and a viewing session selection mechanism to the customers of the viewing system for selecting viewing sessions for transmission by the viewing system to the customers via the Internet. The viewing session selection mechanism includes a customer authoring module providing a mechanism on the website for customers to author customized viewing sessions by selecting a video program to be used for the viewing session. A customer authoring module for the viewing program allows customers to search for and select main features, including movies and feature programs, for inclusion in the play list of viewing programs. The customer authoring module further enables customers to include one or more advertisements and/or one or more interactive components among the video items in the play list for a viewing program. A schedule module provides a mechanism on the website for customers to schedule a date and time for transmission by the viewing system of selected viewing programs and provides a mechanism for customers to optionally elect to make the resulting viewing session publicly available on the website to all customers of the viewing system. Through use of an invitation module on the system website, customers can optionally invite one or more specific other customers of the viewing system to view a selected viewing session in synchrony as a shared viewing group. The viewing system operates to transmit viewing sessions via the Internet at the scheduled day and time to customers of the viewing system who have paid the fee required in order to receive the viewing session. The viewing sessions transmitted to customers via shared viewing groups are synchronized among the customers within the viewing groups while enabling interactive communication between the customers within the viewing groups via the Internet.

A further aspect of the viewing system involves a business rule management feature that, combined and in conjunction with the capability for users to elect and opt-in on advertisement addition into their video programs, gives the users the flexibility to reduce the fee requested for the viewing programs.

In a further aspect of the viewing system, the viewing system website is accessible to providers of video content to the viewing system and a provider authoring module provides a mechanism on the website for providers to author pre-packaged viewing programs by selecting the video items to be included in the play list for the pre-packaged viewing program. The viewing system provides mechanisms for video content providers to input video content and data into the viewing system. The viewing system also provides mechanisms for video advertisements and data to be imported into the viewing system.

A further aspect of the viewing system involves the insertion of placeholders into the play list of viewing programs. At the time of transmitting a viewing session that includes one or more placeholders, the viewing system dynamically replaces the one or more placeholders in the video program with relevant items of video content.

### BRIEF DESCRIPTION OF THE DRAWINGS

FIG. 1 depicts an overview of the Internet-based system for interactive synchronized shared viewing of video content.

FIG. 2 is a flow chart depicting mechanisms of and processes carried out through a customer portion of an Internet website or service site of the viewing system.

FIG. 3A is a flow chart depicting mechanisms of and processes carried out through a notification reply module in the customer portion of the Internet website or service site of the viewing system.

FIG. 3B is a flow chart depicting mechanisms of and processes carried out through a business rules management module of the viewing system.

FIG. 3C is a flow chart depicting mechanisms of and processes carried out through a customer authoring module in the customer portion of the service site of the viewing system.

FIG. 3D depicts flow charts illustrating mechanisms of and processes carried out through an interactive components authoring module and an information exchange module in the customer portion of the service site.

FIG. 4A is a flow chart depicting mechanisms of and processes carried out through a provider portion of the Internet website or service site of the viewing system.

FIG. 4B is a flow chart depicting mechanisms of and processes carried out through an import module in the provider portion of the service site.

FIG. 4C is a flow chart depicting mechanisms of and processes carried out through an advertisement import module in the service site of the viewing system.

FIG. 5A is a flow chart illustrating programmatic messaging on the side of customers while a viewing session is transmitted by the viewing system during the shared viewing event.

FIG. 5B is a diagram depicting interaction between the customer-side programmatic messaging and programmatic messaging that takes place on the side of the system server during the shared viewing event.

FIG. 5C is a flow chart illustrating the programmatic messaging on the side of the system server during the shared viewing event.

FIG. 6A is a flow chart illustrating the steps executed by the viewing system in response to customer input to the viewing system during the shared viewing event.

FIG. 6B is a flow chart illustrating additional steps executed by the viewing system, which interact with the steps depicted in FIG. 6A.

FIG. 7 illustrates a security feature of the viewing system pertaining to the prevention of unauthorized use of video content on the viewing system.

FIG. 8A depicts a method of delivering video content via the Internet to customers of the viewing system.

FIG. 8B depicts an alternative method of delivering video content via the Internet to customers of the viewing system.

FIG. 9A depicts a play list authored by a user of the viewing system wherein the play list includes one or more placeholders.

FIG. 9B depicts the play list actually transmitted, at a later time, to users of the system who have elected to view the play list of FIG. 9A wherein the one or more placeholders have been dynamically replaced with relevant video.

### DESCRIPTION OF THE PREFERRED EMBODIMENT

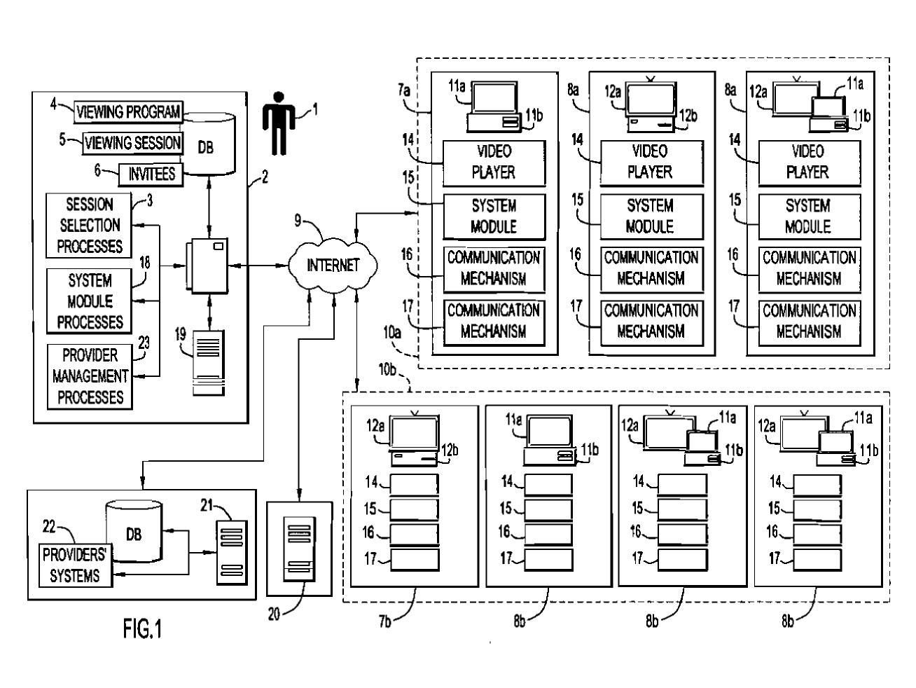

The subject invention involves an Internet-based system for interactive synchronized shared viewing of video content as generally depicted in overview in FIG. 1. The viewing system comprises a system website or service site 2 that is accessible to users of the system via the Internet or world-wide-web 9. Users of the system may include customers, viewers or end users, represented by reference numerals 1, 7a, 7b, 8a and 8b in FIG. 1, who primarily obtain video content from the system for viewing, include providers who primarily supply video content to the system for use by its customers, include sponsors or business partners such as advertisers of products and/or services on the system, and include administrators or managers of the system. As explained further below, an individual person or other entity can at various times function as more than one type of user. The viewing system is primarily intended to be designed as a commercial enterprise in which customers are charged a fee (or credits and or advertisement) for video content obtained through the system. The system is capable of being implemented as a large scale commercial enterprise and can be implemented on a local, regional, national and/or international basis. Users of the system may access the system website 2 by connecting to the Internet 9 in a conventional manner through a suitable Internet-supported or Internet-enabled electronic device. The system website 2 provides appropriate web pages with the appropriate user interface, including graphical user interface (GUI), to implement the input and output of data between the users and the system to carry out the processes, steps and functions described below. Users can input data, execute commands and navigate through the system website using interactive controls such as a mouse and/or keypad, as well as automated controls. The user interface can employ various navigation and interactive tools and other features to facilitate use of the system website and the various features of the viewing system including, but not limited to, menus, links to different web pages and/or web sites, dialog boxes, buttons, lists, drop and drag, editing, cut and paste, scrolling, create and save, files/database entry, highlighting, accept, add, delete and/or modify data, ActiveX and embedded elements, HTML pages, flash user-interfaces and other Internet server or client based technologies.

The viewing system comprises an accessible data base of video content that is transmittable via the Internet 9 for viewing by the customers of the system as explained in greater detail below. During an initial account set-up procedure described further below, the system may require that each customer register with the system, establish a customer identification, such as a user or screen name and personal password, in order for the customer to enter a customer portion of the website 2 using a log-in procedure, and input personal preferences for the customer to take full advantage of the available features of the system. The video content is viewable by the individual customers via any suitable Internet-supported or Internet-enabled viewing device including, by way of illustration, a computer monitor or viewing screen 11a such as that associated with a desktop or notebook computer 11b, a television monitor or viewing screen 12a associated with a set-top box or receiver 12b, a television monitor or viewing screen 12a associated with a computer 11b, and a viewing screen of a portable or hand-held video device. In order to support and implement the features of the system, the viewing devices and/or their associated equipment may include a video player 14 with software supporting Internet-based video delivery, a dedicated viewing system module 15, which can be a plug-in module, with software supporting the operative features of the viewing system, and communication mechanisms 16, 17 enabling a bi-directional Internet path for the exchange of data between the system and its customers and between individual customers themselves. The communication mechanism 16 may be allocated responsibility for transmitting and receiving shared viewing session programming data, and the communication mechanism 17 may be allocated responsibility for transmitting and receiving data based on actions and input made by and between the customers or originating from the system module processes 18.

The video content may originate from various sources including various video content providers. The system itself may be the video content provider by providing video content from a viewing system-hosted or viewing system-owned data base of video content, delivered by a system video server 19 for example, and/or the video content provider may be one or more independent or third-party providers of video content including one or more third-party services partners, business partners or sponsors, indicated by video server 20, and one or more third-party owners of video content represented by video server 21. Typically, each source or provider of video content includes or has access to a data base containing a large quantity or selection of video content transmittable via the Internet. The system-owned data base of video content and the third party-owned data base of video content are labeled DB in FIG. 1. As referred to above and explained in greater detail below, the video content providers will also typically be users of the system website or service site 2, most typically being users of a provider portion of the system website. Various interactions between the system and the video content providers' systems 22 can be managed and carried out through the system website 2 including transactions and interactions with providers' own system data, processes and applications, payments, asset management and reporting, and these are discussed further below. The system website 2 also incorporates a set of provider management processes 23 for use by video content providers to manage various transactions and interactions with the system including processes for importing, publishing and managing the assets of and the associated distribution, consumption and other business rules of the video content providers. Various modes of video transmission can be employed in the viewing system including streaming video, peer-to-peer (P2P) streaming video, and local video files (download or cache). Similarly, through variation in the implementation of the viewing system module 15, the video content may originate from a customer's DVD or Blu-Ray disc played by the customer on the customer's own electronic viewing device system.

A user acting as a customer or viewer 1 in the system can, at any time, act as a leader, host or emcee (MC-master of ceremony) 7a, 7b by setting up a viewing session on the system website for viewing video content individually or contemporaneously or in synchronicity with other customers of the system as part of a shared viewing group. A shared viewing group comprises the emcee and one or more additional customers of the system invited by the emcee via a private or public invitation to participate in the viewing session as guests or buddies who, together with the emcee, view the content selected for the viewing session in synchronicity and at the same time. As an example, FIG. 1 depicts a shared viewing group 10a made up of an emcee 7a and two guests 8a and an alternative shared viewing group 10b made up of an emcee 7b and three guests 8b joining into a “PubliCast” session, as described in greater detail further below. The emcees 7a, 7b and guests 8a, 8b each have their own electronic devices and equipment for connecting to the system website 2 via the Internet 9 and for receiving, playing and viewing video content as described above. It should be appreciated that many variations and compositions of shared viewing groups are possible and that the electronic devices and equipment associated with the customers forming the shared viewing groups may vary. Also, the customers forming the shared viewing groups will typically be at various geographic or physical locations remote or at a distance from one another. Although the primary application for the viewing system is to implement shared viewing groups, it should be appreciated that the viewing system can be employed by its customers to obtain video content for individual private viewing.

Still referring to FIG. 1, the viewing system website 2 executes a set of viewing session selection processes 3 enabling a customer acting as emcee to set up a shared viewing event, which may be called a “BuddyCast” on the system website, by selecting the video program 4 that is to constitute the viewing session, choosing a schedule 5 including a date and time for the viewing session when the selected video program is to be played, and selecting one or more guests or buddies, who are also customers of the system, as invitees 6 to be invited to view the selected video program along with the emcee at the scheduled day and time. The viewing session selection processes 3 are explained in further detail below. At or around the scheduled date and time, the emcee and the invitees who choose to participate in the viewing session as guests connect to the Internet 9 and to the system website 2, initiating the shared viewing event and allowing them to contemporaneously and in synchronicity view the selected video program together as a shared viewing group and, at the same time, allowing the members of the viewing group to interactively communicate with one another in real time via the Internet 9 and their electronic devices. The interactive communication between the members of the shared viewing group can be implemented in various ways, such as in the manner of or known conventionally as “Instant Messaging”, “Live Messaging” and the like, for example. During the shared viewing event, the system module processes 18 manage and control the synchronization and communication between all the viewing system modules 15 of the shared viewing group. Essentially, the system module processes 18 allocates the emcee's viewing system module 15 functions in a server mode during the shared viewing event to control the video seen on the members' viewing devices, and the members' viewing system modules 15 function in a client mode. Various aspects of the video are controlled via the emcee's viewing system module in response to actions of the emcee, including pause, play, seek, fast forward, rewind, stop, etc., and these are transmitted to the viewing system modules of the other members of the viewing group. The system modules 15 supervise the delivery of video to the video players 14 whether the video originates from a viewing system-hosted video server 19, a third-party services partner video server 20, or a third-party owner video server 21, or local video content already on each user's viewing device. In addition, the system modules 15 are responsible for obtaining data from the system pertaining to the video program 4, the schedule 5, and the invitees 6 for viewing sessions. The functions carried out via the viewing system modules 15 are assisted by a specialized and dedicated suite of system module processes 18 of the viewing system. A security feature of the system, described in greater detail below, may also be managed by the processes 18.

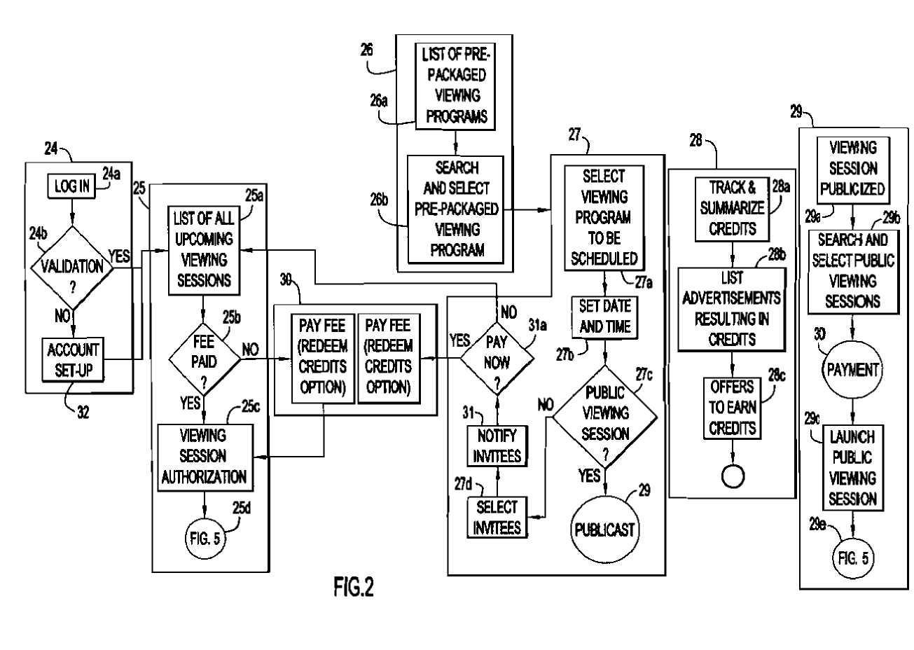

Various features of the viewing system website 2 and its interaction with customers are further depicted in FIG. 2. The system website 2 presents the customer with a log-in procedure 24 for the customer to enter the customer portion of the website. A new customer attempting to enter the system website for the first time will normally be required to complete an account set-up process 32 that directs the customer to register with the viewing system and set various personal preferences and account settings including, but not limited to, a user name or screen name and personal password, email address, language and advertisement preferences. Advertisement preferences are used by the system to tailor or customize advertisements to suit the interests of individual customers, and the role of customized advertisements in the system is discussed further herein below. Personal and demographic information can be requested from the customer in the account set-up process and can also be used by the system to customize advertisements for individual customers. Advertisement and other personal preferences and account settings can be subsequently reviewed and/or modified or updated at any time by the customer on the system website. Once the customer has established an account, the login procedure 24 involves the step of login 24a accomplished by entering the user name and password, which will undergo validation 24b by the viewing system.

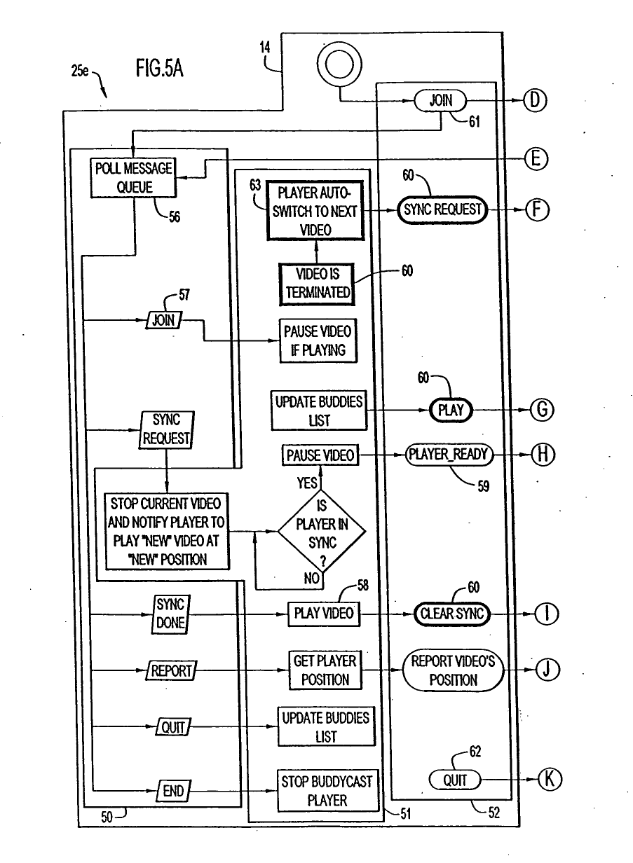

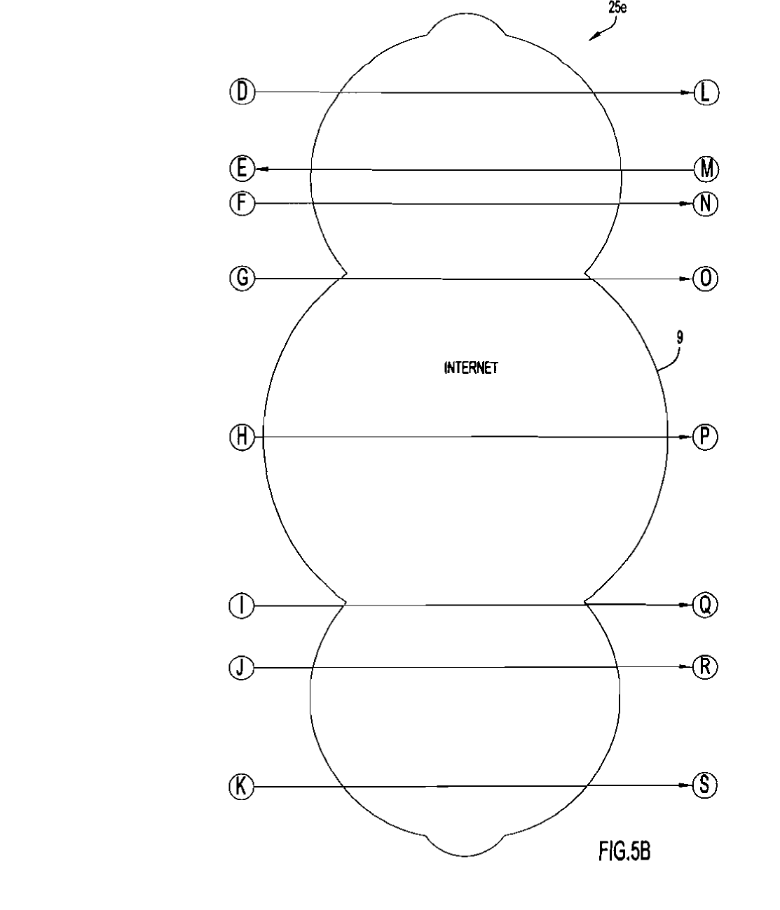

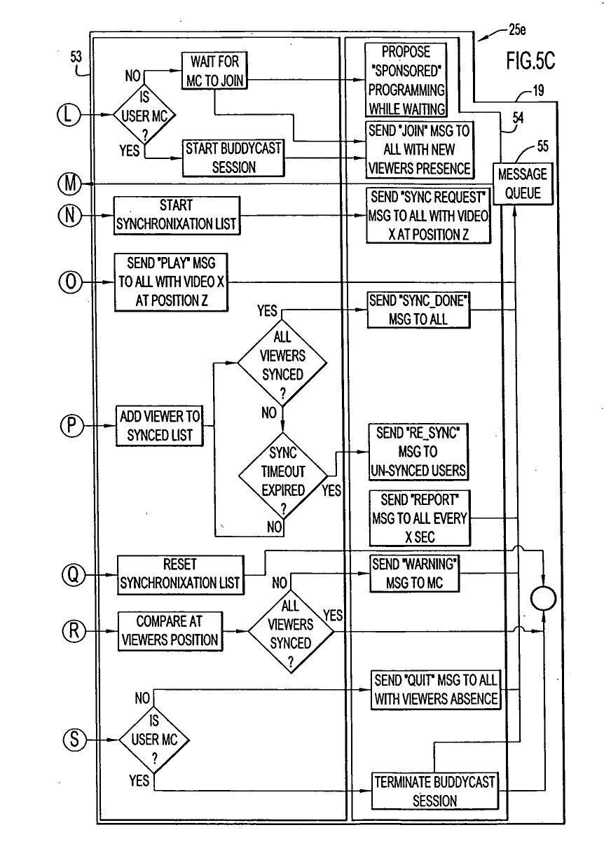

Once the viewing system has validated the customer's login credentials, the customer is presented with a set of different menu and/or action options, with the default option being a viewing session selection mechanism 25, which can be called “My-Cast” on the system website. The viewing system also offers, after login, options to modules 26, 27, 28, 29, 33, 34, 36 and/or 39. The viewing session selection mechanism 25 can be presented in the form of one or more web pages allowing the customer to access a list of all upcoming private and public viewing sessions 25a, for which the customer is the emcee or an invitee or guest. The viewing session selection mechanism 25 also includes a fee-paid check point 25b that operates, prior to the viewing system launching a viewing session for viewing by the customer, to confirm that the customer has paid the fee established for the viewing session. If the viewing system determines that the customer has not paid the requisite fee (No), the system directs the customer to a payment process 30. The payment process 30 is similar to the payment processes conventionally used on Internet websites for the payment of goods and/or services, with the added feature of a redeem credits option that allows the customer to redeem earned credits or rewards toward payment of the fee as explained further below. The payment process 30 can present and manage a “shopping cart” feature as well as the electronic payments. The payment process 30 can involve presenting the customer with optional links and connections to third party payment service providers. Once payment of the requisite fee has been successfully confirmed by the system (Yes), the system confers a viewing session authorization 25c authorizing the customer's electronic device and/or equipment to receive and play the selected viewing session for viewing by the customer during the shared viewing event. The customer can launch a viewing session for immediate delivery or viewing, or the customer can schedule or launch delivery of the viewing session for a later time. The processes and programmatic messaging 25d that are implemented by the viewing system during the shared viewing event are explained further below in connection with FIGS. 5A, 5B and 5C.

Various fee structures may be incorporated in the system including fixed fees and sliding scale fees. The fees may be established proportional to the running or playing time for the viewing sessions such that longer running viewing sessions may cost more than shorter running viewing sessions. The fees may be alternatively and/or additionally established based on the content of the viewing programs. For example, higher fees may be charged for viewing programs that contain “new release” features and/or features of high popularity. In addition to fees being established by the viewing system and/or by providers of video content, the viewing system operates to allow a customer who has authored a viewing program to reduce the resulting requested fee by adding advertisement content to the video program.

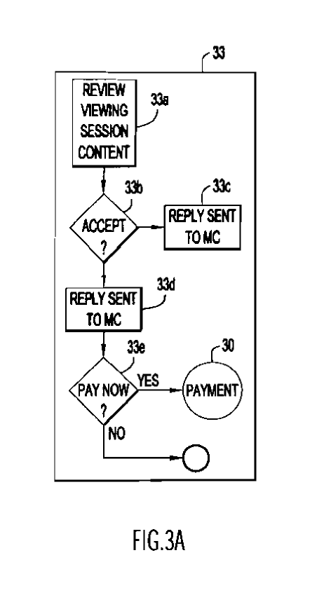

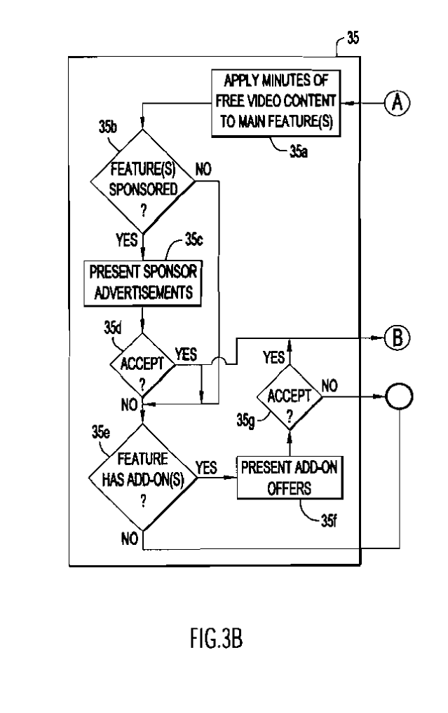

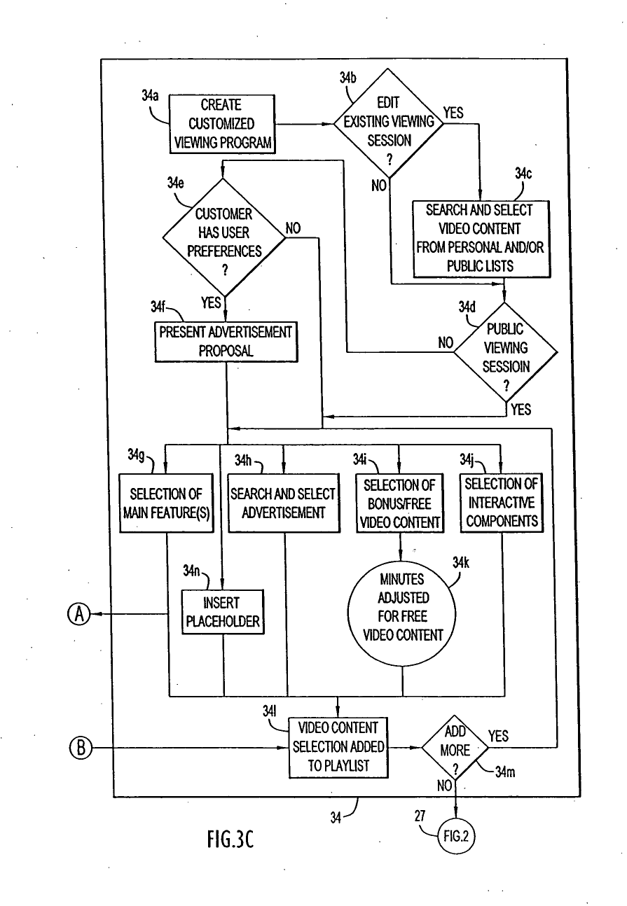

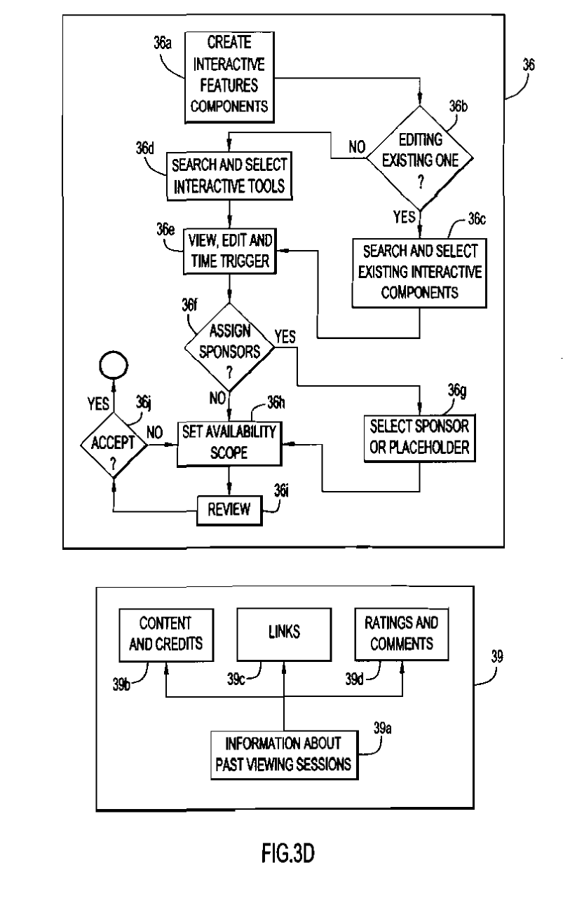

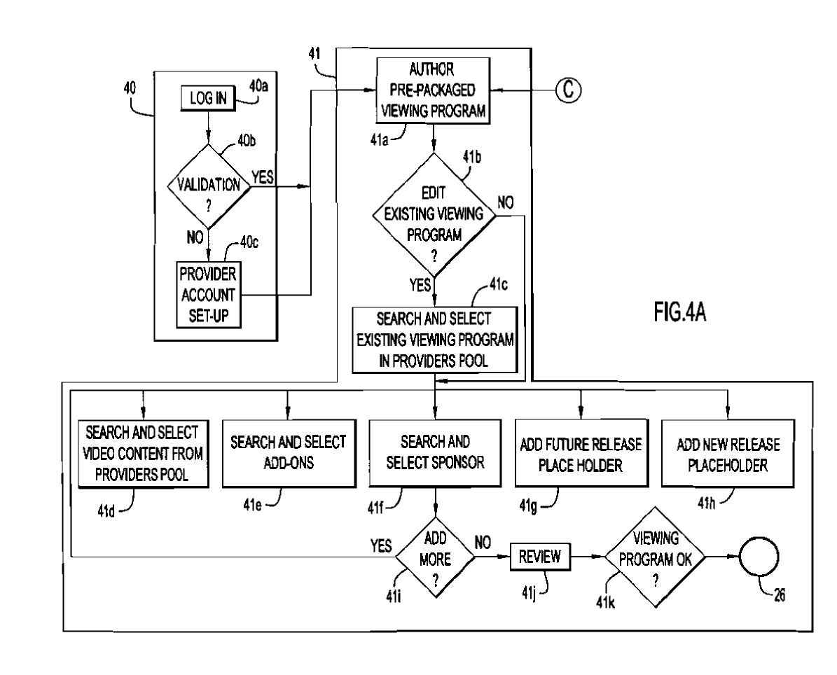

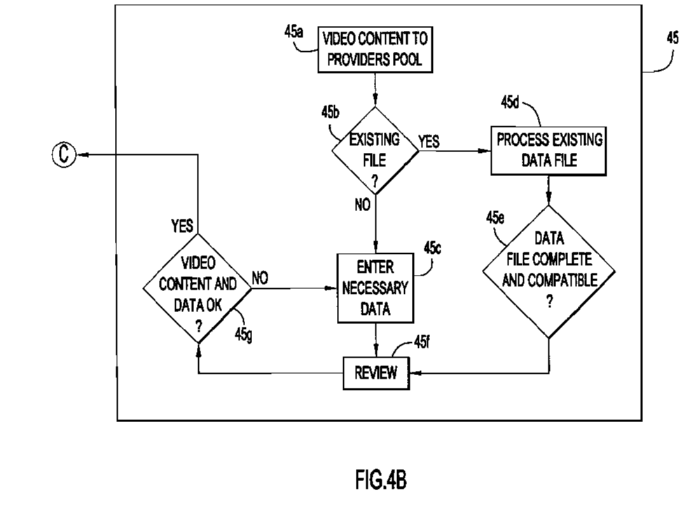

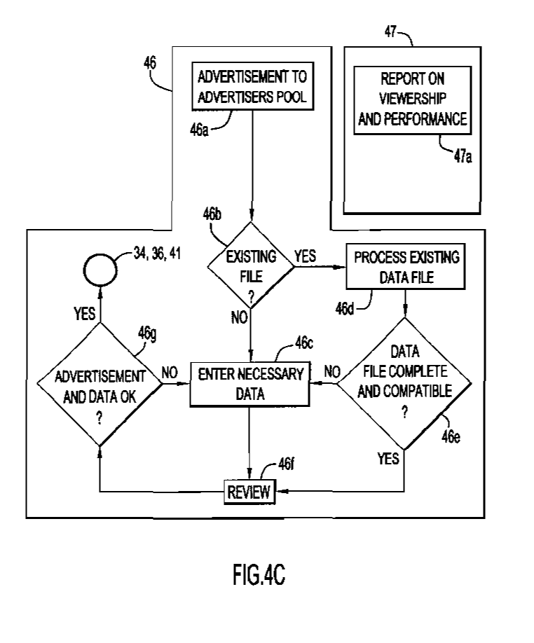

The viewing programs made available by the viewing system to a customer comprise those in which the video content or play list is personally selected by the customer (customized viewing programs and customized play lists), those in which the video content or play list is personally selected by other customers (customized viewing programs and customized play lists), and those in which the video content or play list is pre-selected or pre-packaged by the system itself or by the video content providers (pre-packaged viewing programs and pre-packaged play lists). For pre-packaged viewing programs, the system preferably includes a pre-packaged viewing program module 26, which can be called “Pick & Play” on the system website, that offers the customer one or more web pages with a list or lists of pre-packaged viewing programs 26a from the viewing system's own database of video content and/or from one or more independent video content providers. The pre-packaged viewing programs 26a are presented to the customer in a form allowing the customer to review the video content or play list for the pre-packaged viewing programs. The pre-packaged viewing program module 26 provides a procedural mechanism for the customer to search and select pre-packaged viewing programs 26b composed of pre-selected video content, i.e. video content or play lists pre-selected or “authored” by an entity other than the particular customer, and it thusly provides the customer with a simple way to select one or more ready-made viewing programs/play lists for immediate and easy consumption. As part of the search and selection procedure 26b, the customer can be presented with an appropriate mechanism by which the customer can “preview” viewing programs/play lists. Previews can be presented to the customer in various ways including, but not limited to, trailers, short video clips, synopses, capsule summaries, and/or highlights. In addition to offering customers pre-packaged viewing programs, the viewing system allows the video content or play list for viewing programs to be personally selected or “authored” by the customers themselves, resulting in customized viewing programs. The features and methodology of the system pertaining to personal selection or “authoring” of customized viewing programs by customers are discussed in greater detail below in connection with FIGS. 3C and 3D. The features and methodology of the system pertaining to pre-selection or “authoring” of pre-packaged viewing programs by video content providers are discussed in greater detail below in connection with FIGS. 4A and 4B.

The customer can serve as emcee for a customized viewing program authored by the customer, for a customized viewing program authored by another customer and made publicly available on the system website, or for a pre-packaged viewing program selected by the customer. Still referring to FIG. 2, a customer who serves as emcee for a customized or pre-packaged viewing program employs a schedule module 27 of the system which provides a procedural mechanism for the customer to schedule delivery or transmittal of the viewing program by the viewing system and for the customer acting as emcee to select or “invite” other customers to participate in the viewing session as guests or buddies. In particular, the schedule module 27 enables the emcee to designate specific customers to be invited to participate as guests or buddies in the viewing session, i.e. a private viewing session, or to make the viewing session available for viewing by all customers of the system, i.e. a public viewing session. The schedule module 27 provides a procedural mechanism for the customer to select which particular viewing program is being scheduled 27a, and a procedural mechanism for the customer to set or select the date and time when the viewing session is to happen 27b. The schedule module 27 also provides the customer with the optional selection 27c of making the viewing session a public viewing session. If the customer elects to make the viewing session public (Yes), a public viewing session module 29, which can be called “Publicast” on the system website, manages various processes associated with public viewing sessions as described further below.

If the customer emcee does not choose (No) the option 27c of making the viewing session public, the schedule module 27 presents the customer emcee with a procedural mechanism to identify or select specific other customers as invitees 27d who will be invited to participate or join the viewing session as guests or buddies. Invitees may be considered potential guests or buddies since they may or may not choose to participate in the viewing session. Where the customer emcee designates specific customer invitees as potential guests or buddies to participate in a private viewing session, a notification or invitation module 31 of the system implements a process to notify invitees, by which the viewing system automatically sends a notification or invitation to the designated customer invitee(s) including information on the upcoming scheduled viewing session to which they have been invited by the emcee. The actual notification may be sent to the designated customer invitee(s) in various formats including various electronic formats such as email and/or text messaging. The format used to notify a designated customer invitee of an upcoming scheduled viewing session will have been specified by the customer as one of the user preferences selected during the account set-up processes 32. The notification module 31 further presents a payment option 31a to the customer invitees that interacts with the payment process 30 so that invitees can pay in advance (Pay Now—YES) or postpone payment (Pay Now—NO) of the requisite fee for viewing sessions to which they have been invited and choose to participate in as guests or buddies.

With respect to public viewing sessions, the public viewing session module 29 of the system provides procedural mechanisms for publicizing viewing sessions 29a on the system website, for allowing all customers of the system to search and select from all available public viewing sessions on the website 29b, and for launching delivery of a selected public viewing session 29c. The public viewing sessions may include the pre-packaged viewing programs of video content providers, in which case the video content providers essentially serve also as emcees, and the customized viewing programs created by customers and made publically available on the system, in which case the customers essentially serve also as video content providers. The public viewing session module 29 allows customers to search the public viewing sessions 29b in accordance with various search parameters and/or terms such as session calendar, genre, date of release, title, actors, director, name of emcee, and/or name of video content provider. The public viewing session module 29 may be integrated in or operate in conjunction with the viewing session selection mechanism 25. The public viewing session module 29 also interacts with the payment process 30 so that the fee associated with a public viewing program selected by the customer is paid prior to the system launching delivery or transmittal of the selected public viewing session 29c to the customer.

The viewing system is designed so that various types and/or items of video may be incorporated into the video content or play list for a viewing program including one or more main features, such as movies or feature programs, as well as video advertisements and/or video interactive components. Essentially a play list is a list of video items wherein the video items are “played” or transmitted for viewing in the order that they appear in the play list. Advertisements may pertain to or include, but are not limited to, announcements, discount offers, bonuses, rebates, promotions, by-products/by-services, ancillary products/ancillary services, and/or tie-in products/tie-in services, bundled products/bundled services (e.g. Rent Movie 1, Rent Movie 2 at half price), special financing or payment plans, various other products and/or services, commercials, “infomercials”, public service announcements, vignettes known as “trailers”, “previews” or “coming attractions” for movies and/or programs currently released or to be released in the future, and/or any type of sales, marketing and promotional materials. The nature of the advertisements and/or the products and/or services to which they pertain that are presented by the viewing system to a customer can be automatically customized or tailored by the system for the individual customer in accordance with the user preferences entered into the system. Customization of advertisements to reflect the interests, wants and/or needs of individual customers of the system can be accomplished in various ways. For example, a customer authoring a viewing program containing one or more advertisements may be presented by the system with suggested advertisements for incorporation into the viewing program, and the system will pick the suggested advertisements based on them having an association or relevance to the preferences or other personal information entered by the customer in the system, e.g. customers indicating a car buying interest are presented with suggested advertisements pertaining to new cars, customers indicating an interest in travel are presented with suggested advertisements pertaining to travel, customers indicating an infant household member are presented with suggested advertisements pertaining to baby products, etc. The customer emcee is then able to include advertisements in the viewing program that are related to a current personal interest or buying decision for which feedback from personal acquaintances is desired. When the customer emcee then invites other customers to the viewing session, who oftentimes share the same personal interests and/or demographics as the emcee and/or may know the emcee on a personal basis, the invitees who have an interest in the subject matter of the advertisements and/or knowledge relevant to the emcee's purchasing decisions will be incentivized to participate in the viewing session as a guest or buddy. As previously pointed out, the invitees have an opportunity to review the play list for a viewing program, and the play list can include information pertaining to the subject matter of advertisements included in the viewing program. In this way, advertisements are essentially customized through the social networking aspect of the viewing system. Another way in which advertisements can be automatically tailored or customized for individual customers is for an author of a viewing program to select one or more non-specific advertisement components or advertisement slots or positions, which can be called a “placeholder” or “asset placeholder” on the system website, for inclusion in the play list for a viewing program. Then, whenever a customer views the viewing program, the system automatically inserts at the location of the placeholder(s) an advertisement(s) that has an association or relevance to that customer's preferences or other personal information entered in the system. The role of placeholders in the viewing system is described in further detail below.

The advertisements used in the viewing system may include various types of interactive components designed to elicit an action or input from customers viewing the advertisements, and the system receives, processes and/or responds to the action or input entered by customers viewing the advertisements. Whenever a customer views and/or interacts with an advertisement, the customer will earn a credit, which may be referred to as a “Time Credit” or “Stand-By Credit” on the system website depending on at what point in the process it is earned. Credits can be earned by viewing and/or interacting with advertisements at the time of viewing (consumption) during the shared viewing event or thereafter when the consumer goes to “history, reviews and links” module of the viewing system as described further below. Credits can be earned for just viewing an advertisement and, where the advertisement has interactive components, additional credits can be earned for taking part in the interactive components. The number of credits earned for viewing advertisements and/or taking part in interactive components of advertisements can be pre-established by the system. Credits are redeemable by the customer during the payment process 30 toward the fee owed by the customer for a selected viewing program(s). The management and redemption of credits is handled by a credit management module 28 of the system as seen in FIG. 2.

The credit management module 28 functions to track and summarize credits 28a associated with each viewing customer, including earned credits and credits that may be considered “pending” until the customer performs or fulfills some further action required by the system. The track and summarize credits function 28a provides a mechanism for viewing customers to obtain a display or summary showing the number, type and status of their credits. The credit management module 28 further functions to maintain and display a list 28b of all advertisements resulting in credits to the customer, and to deliver offers 28c to the customer to earn credits.

Various customer oriented processes that are carried out by the viewing system via the customer portion of the system website are depicted in FIGS. 3A, 3B, 3C and 3D. FIG. 3A shows a notification reply module 33, which can be called “Email Invite” on the system website, that governs the processes that occur when a customer invitee receives a notification or invitation from an emcee (MC) to participate as a guest in a public or private viewing session. The customer invitee can, on the system website through the notification reply module 33, review the video program, i.e. play list, of a viewing session to which the customer has been invited 33a, can accept (Y—Yes) or not accept (N—No) an invitation to a viewing session 33b and, if an invitation is accepted, the customer can elect to then pay (Y—Yes) or not pay (N—No) 33e the fee that the customer owes for the viewing session. The payment aspect of the notification reply module 33 is interactive with the payment process 30 in that the customer is directed to the payment process 30 upon election to pay the fee for the viewing session. When the invitee accepts or declines an invitation to a viewing session, the notification reply module 33 directs transmittal of a reply, typically email or other suitable electronic format, back to the emcee indicating that the invitee has accepted 33d or has not accepted 33c the invitation. In conjunction with a reply of non-acceptance 33c, the notification reply module 33 will change or update the viewing session record on the system website to show that the invitee has not accepted the invitation. The notification reply module can serve to make available to the emcee, and to all invitees selected by the emcee, a viewing session record that indicates which invitees have accepted the invitation, which have not accepted the invitation, and which have not yet replied to the invitation.

FIG. 3C shows a customer authoring module 34 of the system, which can be called “Program Authoring” on the customer portion of the system website, that controls the processes associated with creating customized viewing programs where the customer personally selects the video content or play list for a viewing program. The customer authoring module 34 provides a mechanism that allows a customer to create or author a customized, self-generated viewing program 34a and make it available on the system as a private or public viewing program. The customer creating a new viewing program may search for and select 34c video content for the viewing session from a personal play list, collection or pool of video content that the customer has already compiled and saved on the system, such as in a file, database entry or other retrievable location on the system website, and/or from a “public” play list, collection or pool of video content accessible on the system website. Authoring a viewing program may entail editing 34b an existing viewing program or play list of video content 34b that the customer has already created and saved on the system, such as in a file, database entry or other retrievable location on the system website, or editing an existing viewing program created by another customer or entity and made publicly available on the system website. Authoring a viewing program may entail creating an entirely new play list of video content to constitute the viewing program at the time of authoring. When editing an existing program created by someone else, the authoring customer can modify the video program only by adding items to it while all editing options, including item removal, are possible when using video programs that the customer has previously and entirely created. The customer authoring module 34 also presents the customer with a selection feature 34d by which the customer elects (Y—Yes) to make the viewing program a public one or elects not to (N—No) make the viewing program public. Part of the authoring process involves the incorporation of advertisements and/or interactive components and/or placeholders into the video content or play list making up the viewing program, and these mechanisms and processes are discussed further below.

Where the customer/author of a viewing program uses the selection feature 34d to designate the viewing program as a public one available to all other customers of the system, the business rules of the viewing system are designed so that the system allocates the customer/author a reward whenever another customer views the viewing program, and consequently the advertisements contained therein. The reward may be based on various factors, such as a percentage of the revenue derived from the advertisements contained within the viewing program, and may be transformed into credits redeemable by the customer/author as discussed herein above. The customer/author thusly becomes a vested party in the programming distribution chain and is motivated to create a widely appealing viewing program, as facilitated through the use of the interactive components authoring module 36 of the viewing system described further below. This feature of the viewing system is expected to be especially attractive to “movie buffs” and blog-minded aficionados who can create viewing programs that are unique and compelling entertainment packages enhanced by the customer's/author's in-depth personal knowledge to enrich the viewing experience for customers/viewers of the viewing program.

Where the customer/author of a viewing program uses the selection feature 34d to designate the viewing session as a private viewing program, the system checks whether the customer/author has user preferences 34e entered in the system and, if so, the system presents the customer/author with an advertisement proposal 34f tailored or customized in accordance with the user preferences that the customer/author has entered into the system. The system also provides an advertisement search and selection mechanism 34h for the customer/author to search and select from a large database of advertisements accessible on the viewing system. The search for advertisements can be conducted using a wide range of search parameters. In searching and selecting advertisements, the customer/author is presented with information pertaining to credits that can be earned by customers/viewers for viewing and/or interacting with the advertisements. The advertisement search and selection mechanism 34h can be designed to allow customers/authors to search for advertisements based on various characteristics including type of products and/or services advertised, earnable credits, and interactive components or features. The advertisement search and selection mechanism 34h can be designed to allow customers/authors to view and/or to preview the advertisements.

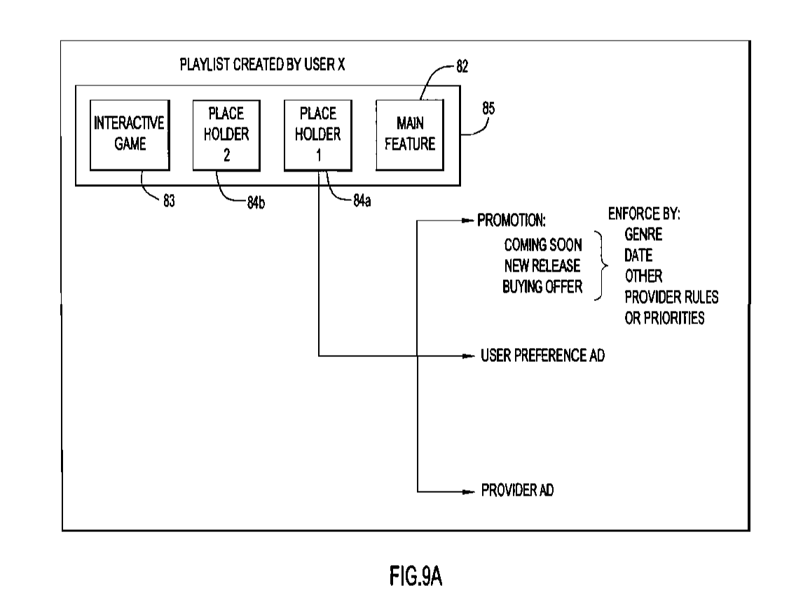

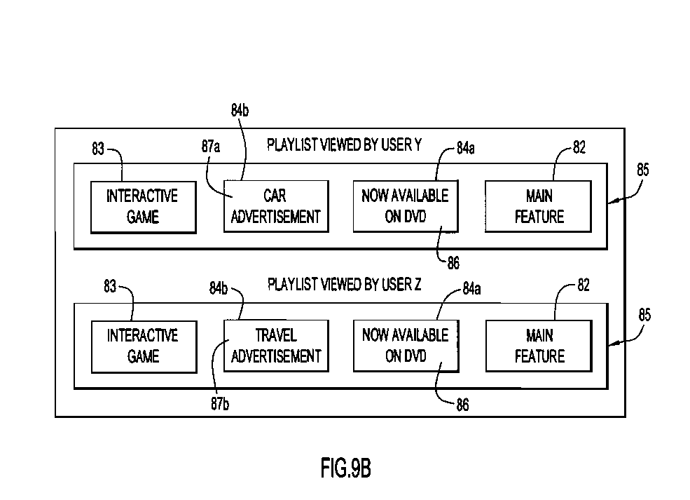

Still referring to FIG. 3C, customer authoring of viewing programs involves search and selection of one or more main features 34g, such as movies or feature programs, search and selection of one or more advertisements 34h associated with earnable time credits, search and selection of bonus/free video content 34i whose running or playing time is not charged to the viewing program, and search and selection of interactive components or features 34j including, but not limited to, closed captioning, trivia, comments, personal knowledge, games, analysis, opinions and/or quizzes to be made part of the viewing session. As already pointed out above, a wide range of search parameters can be used in the search procedures involved in the search and selection processes and mechanisms 34g, 34h, 34i and 34j. The selection of the main feature(s) 34g is carried out by the customer/author as explained herein above and as represented by mechanisms and processes 34b and 34c. The search and selection of advertisements 34h can be implemented as described above and, in addition, the viewing system presents the customer with various proposed advertisements and offers under the business rules of the viewing system as managed by the business rules management module 35 shown in FIG. 3B and described further below. Rather than selecting a specific advertisement for inclusion in the viewing program, the customer/author can insert an advertisement placeholder 34n in the play list as explained further below in connection with FIGS. 9A and 9B. When the viewing program being authored contains bonus or free video content, the minutes of running time for the viewing program are adjusted 34k so that the minutes of bonus or free video content are not counted as chargeable minutes, and the adjustment is handled through the business rules management module 35. As seen in FIG. 3C, the processes performed by the customer authoring module 34 interact with those performed by the business rules management module 35 as indicated by arrows and letters “A” and “B” in FIGS. 3B and 3C. The mechanisms and processes involved in the selection of interactive components 34j are depicted by the interactive components authoring module 36 in FIG. 3D and are explained in further detail below.

As a result of the customer authoring processes, video items are added to the playlist 34l that is to constitute the viewing program. The viewing session customer authoring and/or editing continues or “loops on” through check point 34m, allowing further video content to be added or edited until the video content or items making up the programming play list for the viewing program is satisfactory to the customer/author and/or its playing or running time exceeds the number of minutes allocated by the system for the viewing program, as managed by a set of processes performed by the business rules management module 35 of the system running in parallel with the processes performed by the customer authoring module 34. Once the customer/author has completed the authoring process and thereby created a viewing program to be made available on the system website as a private or public viewing program, the customer/author proceeds to utilize the schedule module 27 and its mechanisms and processes to schedule the date and time for delivery or transmission of the viewing program by the system as previously described above and shown in FIG. 2.

The customer authoring processes are governed by the business rules of the system, which are implemented through the business rules management module 35 shown in FIG. 3B. The business rules management module 35 is implicitly a part of the customer authoring process but is also a stand-alone process or set of processes and mechanisms to carry out such process(es). The principal tasks or processes performed by the business rules management module 35 are to manage the minutes or time allocated or permitted by the system for a viewing program and/or for the main feature(s) selected by the customer/author to be part of a viewing program, to manage the amount of free minutes or time associated with the bonus/free video content, and to propose advertisements for incorporation into the viewing program. As mentioned hereinabove, the nature and content of the advertisements may vary widely. The advertisements can be those provided by video content providers to be bundled with the main feature(s) and/or those provided by other sponsors or business partners. The advertisements proposed by the business rules management module 35 may be accepted or not accepted by the customer/author, and accepted advertisements will be incorporated in the viewing program.

A representative stream of processes that are implemented by the business rules management module 35 is depicted in FIG. 3B. The main feature(s) 34g selected by the customer/author when authoring a viewing program is/are processed by the business rules management module 35 to apply to the viewing program any minutes of free video content associated with the selected main feature(s). As pointed out above in connection with the procedure and mechanism 34k, the running time of the viewing program is adjusted accordingly so that the minutes of free video content do not incur a fee. For each main feature selected by the customer/author, the business rules management module 35 determines whether the main feature is (Y—Yes) or is not (N—No) sponsored as shown at 35b. A sponsor will typically be an independent party that has entered into a business relationship with the viewing system enterprise. Sponsors can be of various types, including video content providers and/or providers of other types of goods and/or services. A main feature can have one or more than one sponsor. If the main feature is determined to be sponsored, the business rules management module 35 operates to present one or more sponsor advertisements 35c to the customer/author during the authoring process. The sponsor advertisement(s) will be presented to the customer/author along with an indication of credits that can be earned from viewing and/or interacting with the sponsor advertisement(s). Sponsor advertisements can be presented to the customer/author in various ways as described above in connection with the search and selection of advertisements 34h. The presentation of sponsor advertisements involves presenting the customer/author with an accept option 35d by which the customer/author can accept (Y—Yes) or not accept (N—No) a presented sponsor advertisement. If accepted by the customer/author, the sponsor advertisement will be incorporated in the viewing program and will become part of the video content or play list for the viewing program. A sponsor advertisement not accepted by the customer/author will not be so incorporated into the viewing program. Rather than selecting a specific sponsor advertisement for inclusion the viewing program, the customer/author can select a sponsor placeholder for insertion in the play list. The business rules of the system can be designed to assign the customer/author a reward or credit in response to selection of a sponsor advertisement and/or sponsor placeholder. The use of placeholders in the system is explained further below.

For each main feature selected by the customer/author, the business rules managements module 35 operates further to determine whether the main feature has any add-ons 35e associated therewith. If a main feature is determined to have (Y—Yes) one or more associated add-ons, the business rules management module 35 operates to present one or more add-on offers 35f to the customer/author during the authoring process. Add-on offers can pertain to products and/or services and can vary widely in content. Add-on offers can include advertisements as described above, discount offers, bundled products and/or services offers, tie-in products and/or services, ancillary products and/or services, rebates and/or various diverse sales incentives or promotions. The customer/author is able to review the add-on offers in a manner similar to that described above for the review of advertisements. The presentation of add-on offers involves presenting the customer/author with an accept option 35g by which the customer/author can accept (Y—Yes) or not accept (N—No) a presented add-on offer. An add-on offer accepted by the customer/author will be incorporated in the viewing program and will become part of the video content or play list for the viewing program. An add-on offer not accepted by the customer/author will not be made part of the viewing program. The business rules of the system can be designed to assign the customer a reward or credit in return for accepting an add-on offer.

The interactive components authoring module 36 of the viewing system provides an easy-to-use, web-based interface with pre-existing templates to assist a customer/author in creating interactive components or features and in associating them with the timing of the viewing program. The interactive components authoring module 36 is shown in FIG. 3D and provides mechanisms and processes by which interactive components or features themselves can be created or authored 36a by the customer/author for incorporation into a viewing program at step 34j in the viewing program authoring process. Creating interactive components may entail editing existing completed or partially completed interactive components 36b retrievable on the system website. As part of the editing process 36b, the interactive components module 36 provides a mechanism and procedure 36c by which the customer/author can search and select existing interactive components for editing, and the existing interactive components can be searched and selected from a personal pool or collection of interactive components that the customer/author has already created and saved on the system, such as in a file, database entry or other retrievable location on the system, and/or from a general publicly available pool or collection of prepared interactive components accessible on the system website. Creating interactive components may additionally or alternatively involve creating completely new interactive components, and the interactive components authoring module 36 provides a mechanism and procedure 36a by which the customer/author can search and select from interactive component authoring tools maintained by and accessible on the system to assist and facilitate the creation of interactive components. Various types of interactive component tools can be made available on the system including, but not limited to, templates, graphics, text entry, grids, graphs, charts, game boards, puzzles, dialog boxes, illustrations, maps, photos, patterns, artwork, titles, and icons. The interactive components authoring module 36 further provides a mechanism and procedure 36e for the customer/author to view the video content selected for the viewing program being authored, to edit the interactive components in conjunction with viewing the video content, and to “time trigger” the interactive component(s). Time triggering the interactive component(s) involves selecting the location of the interactive component(s) in the play list and therefore, the point or points in time at which the interactive component(s) will appear in the viewing program. The interactive components can be set or time triggered for delivery during or in parallel with the delivery of other video content of the viewing program, as a post-main feature presentation, and/or as a pre-main feature presentation. Since many various types of interactive components can be created or authored via the interactive components authoring module 36, a customer/author with in-depth knowledge pertaining to the video content and/or related subject(s) is able to incorporate that knowledge into the viewing program via the interactive components and to thereby share that knowledge with the other participants in the viewing session. Similarly, the authoring module 36 can be used by translators to create interactive closed caption components in order to offer multi-language versions of the video content. The interactive components authoring module 36 also provides the customer/author with the option 36f to assign a sponsor to the viewing program by selecting a sponsor or by inserting a sponsor placeholder 36g within the viewing program, for which the customer/author may be ascribed a reward as previously pointed out above. If a sponsor is selected, the selected sponsor is incorporated in the processing performed by the system as in steps 35b and 35c. The use of placeholders in the viewing system is explained in further detail below.

The interactive components authoring module 36 can also provide a procedure and mechanism 36h for the customer/author to set the scope or level of availability for the interactive component(s) created by the customer/author through their own personal effort. The procedure and mechanism 36h can be designed to allow the customer/author to elect to make an interactive component publicly available on the system website or not publicly available, i.e. private. Interactive components that are elected to be made public can be made part of the general publicly available pool of interactive components made available on the system website to other customers/authors at 36c. Interactive components that are elected to be made private will only be available to customers/viewers who are authorized by the customer/author to use it in their own video program authoring.

The interactive components authoring module 36 provides a procedure and mechanism 36i enabling the customer/author to review the interactive component created by the customer/author and a procedure and mechanism 36j for accepting the interactive component. If the interactive component is not accepted, the customer/author can return to the previous interactive component authoring processes and mechanisms to modify the interactive component until the customer/author is satisfied with the final interactive component product. The interactive components authored using the module 36 and the mechanisms/procedures 36a-36j are incorporated in the customer-authored viewing program at 34j.

The system further comprises an information exchange module 39, which can also be called a “history, review and link” module, as further seen in FIG. 3D. The information exchange module 39 provides procedures and mechanisms for customers/authors to access or retrieve information about past viewing sessions 39a including the programming content and credits earned 39b on any of the video content of past viewing sessions, links 39c to third-party sponsors, partners, advertisers and/or video content providers and to e-commerce opportunities, and a mechanism 39d by which customers can enter ratings, reviews and comments 39d about video content, viewing programs and/or viewing sessions and can gain access to ratings, reviews and comments entered by others.

The system website or service site further comprises features and methodology to implement interaction between the system and the providers of video content to the system as depicted in FIGS. 4A and 4B. As shown in FIG. 4A, a provider portion of the system website is accessed by providers via a log-in procedure 40, which is similar to the log-in procedure 24 described above for customers of the system, except that the account set-up process 40c for providers will involve different requirements, selections and data entry than that for customers, including different account settings and user preferences. Typically, the provider will be required to enter a user name or screen name and password, email address, and options by which the provider can also author viewing sessions. Once the provider has established an account, access to the provider portion of the system website is gained by the provider entering the user name and password in login 40a, which will undergo validation 40b by the viewing system.

Entry into the provider portion of the system website presents providers with an interactive and dynamic video distribution interface 41, in the form of one or more web pages, which can be called “iDVD” on the system website, for implementing a viewing program authoring process for providers that is essentially like the viewing program authoring process for customers as discussed above in connection with FIG. 3C, but with the provider being the author and having access to additional provider-specific business rules on placeholders. In the context of the viewing system, the term “iDVD” stands for “Interactive and Dynamic Video Distribution”. The provider authoring process enabled through the interface 41, which serves as a provider authoring module, allows providers to author or create pre-packaged viewing programs 41a, which constitute the pre-packaged viewing programs made available to customers on the system through the pre-packaged viewing program module 26 described above. Authoring pre-packaged viewing programs may involve editing an existing pre-packaged viewing program 41b or play list of video content that the provider has already created and saved on the system, such as in a file, database entry or other retrievable location on the system, or creating a new pre-packaged viewing program. In conjunction with the editing process, the system provides a procedure and mechanism 41c for a provider to search and select existing viewing programs in the provider's pool of existing viewing programs in order to select the existing viewing program that is to be edited. An existing viewing session that is selected for editing as a result of search and selection 41c can be edited in various ways including the incorporation of video content and/or other components as explained below and represented at 41d, 41e, 41f, 41g and 41h.

Video content for a pre-packaged viewing program being newly created or authored and for one being created by editing an existing pre-packaged viewing program selected in step 41c is obtained via a video content selection mechanism and procedure 41d of the system that enables the provider to search and select video content from the provider's pool or list of video content. The search and selection procedures involved in the provider authoring process can be conducted using many various search parameters as described previously above. As part of the provider authoring process, the provider may assign one or more add-ons to the viewing program, which are searched for and selected from the provider's pool of add-ons using an add-on selection mechanism 41e. The interface 41 and the processes enabled thereby allow providers to incorporate advertisements into the viewing programs they author as further explained in connection with the advertisement import module 46 shown in FIG. 4C. Accordingly, video content providers may create or author pre-packaged viewing programs including one or more main features, which may be selected via mechanism 41d, as well as one or more advertisements or other video content that the providers desire to distribute to the customers of the system. The sponsor selection mechanism 41f allows the provider/author to search and select a third party sponsor from a list or pool of sponsors who have a business relationship with the provider and/or the viewing system. Selection of a sponsor results in inclusion of the sponsor's advertisements in the viewing program. The sponsor selection mechanism 41f, or one similar to it, can also be used by content providers to associate main features with sponsors for the purpose of steps 35b and 35c discussed above. The placeholder insertion mechanisms and procedures 41g and 41h allow the provider/author to add or insert placeholders into the video content or play list for the viewing program. Each placeholder insertion mechanism 41g and 41h is associated with a different placeholder corresponding to different categories or types of information or subject matter. By way of example, the placeholder for placeholder insertion mechanism 41g in FIG. 4A is a “future release” placeholder pertaining to main features scheduled for future release. The placeholder for placeholder insertion mechanism 41h in FIG. 4A is a “new release” placeholder pertaining to recently released main features. Any number of placeholder insertion mechanisms having placeholders covering different subject areas or information can be provided in the system including sponsor placeholders as referred to above and advertisement placeholders pertaining to advertisements for goods and/or services. Each placeholder is associated with video relevant to the subject area or information to which the placeholder pertains. For example, the future release placeholder may be associated with a trailer, preview or highlights from a main feature to be released in the future, and can convey information such as movie title, genre, actors, director and anticipated release date. The new release placeholder may be associated with a trailer, preview or highlights from a newly released main feature and can convey similar information. An advertisement placeholder can be associated with a video advertisement for a product(s) and/or service(s).

As shown in FIG. 4B, an import module 45 of the viewing system allows the provider/author to enter and/or edit the video for placeholders so that they contain the current and/or highest priority information. For example, the video for the future release placeholder could be changed by the provider/author on a weekly basis via the import module 45 to cover a different and/or highest priority future release main feature and/or to provide the latest or most current information pertaining to the future release of a main feature. The video for the new release placeholder and for advertisement placeholders can be similarly entered and/or edited by the provider/author to contain the most up-to-date and/or highest priority information. When a placeholder has been inserted into the play list for a viewing program, the video that will be transmitted by the viewing system at the point in time where the placeholder occurs during the viewing session will be the video that is associated with the placeholder and has most recently been entered and/or edited by the provider/author.

The provider authoring and/or editing process continues or “loops on” through check point 41i, allowing further video content to be added or edited until the video content or programming play list making up the pre-packaged viewing program is satisfactory to the provider. The system provides a review mechanism 41j by which the completed pre-packaged viewing session can be reviewed, and an accept mechanism 41k for thereafter accepting the pre-packaged viewing program. The pre-packaged viewing programs thusly authored by providers are then made available through the system to the customers via the pre-packaged viewing program module 26 on the customer portion of the system website as described above.

As shown by arrows and the letter “C” in FIGS. 4A and 4B, the import module 45 of the system interacts with the provider authoring module 41. The import module 45 provides an interface, such as one or more web pages, in the provider portion of the system website for providers to input all core assets or material of the provider for use in the provider authoring process including but not limited to main features, placeholder video, trailers, promotions, add-ons, by-products, special offers, bundles, and provider advertisements. The import module 45 includes a video input mechanism and procedure 45a for the provider to input or add video to its pool of video content on the system. A data checkpoint 45b of the import module 45 operates to check whether a data file containing necessary data pertaining to the video being inputted or added exists on the system. If not (N—No), the import module 45 provides a data input mechanism 45c for the provider to input the necessary data for the video. The type of data that is entered via the data input mechanism 45c will vary depending on the video and can include general data, metadata and any information needed for the video to be relevant and up-to-date. If the data checkpoint 45b finds that a data file pertaining to the video already exists (Y—Yes) on the system, a data file processing mechanism and procedure 45d processes the data in the data file, and a data sufficiency checkpoint 45e determines whether or not the data file is complete and compatible with the necessary data requirements for the video. If the data sufficiency checkpoint 45e determines that the data file is not sufficient (N—No), the provider is directed to the data input mechanism and procedure 45c in order to enter the necessary data. Once all necessary data has been entered, the provider can review the completed video product via a review mechanism and procedure 45f and, if the video and associated data in the completed video product are satisfactory, the video product is accepted via an accept mechanism and procedure 45g. The accepted video product then becomes part of the video content employed by the provider authoring module 41.

The import module 45 cooperates with the provider authoring module 41 to allow providers to dynamically tap into the video content pool and automatically output, in a just-in-time fashion, viewing sessions with play lists containing the most current and/or highest priority information relevant to customers and to automatically import them into the viewing system. Viewing sessions can thusly be created containing the latest and/or the highest priority “Coming Soon” and “New Release” trailers and/or promotional video assets. As an example, a provider imports into the system on June 1 a future release trailer T1 for a movie to be available or opening on the system (or in theaters) on June 15. A viewing program authored by the provider containing the future release placeholder 41g will, when delivered to customers of the system subsequent to the import of the future release trailer T1, automatically include the trailer T1 in its play list at the location of the future release placeholder 41g. If the provider imports into the system on June 10 a new or modified future release trailer T2, for instance a trailer for a different movie to be released on the system (or in theaters) on July 1, the same viewing program will be automatically and transparently refreshed and updated to incorporate the trailer T2 in its play list at the location of the future release placeholder 41g.

Advertisements may be imported or inputted into the system through an advertisement import module 46 as shown in FIG. 4C. The mechanisms and processes of the advertisement import module 46 are similar to those of the import module 45 but with a different set of business requirements, data requirements and core asset usage, including the entry of data or information pertaining to credits and/or rewards to be awarded to customers for viewing and/or interacting with the advertisements. The advertisement import module 46 will typically be employed by advertisers, who may be video content providers, independent third party sponsors, advertisers and/or other entities having a business relationship with the content providers and/or with the viewing system. The advertisement import module 46 provides an advertisement input mechanism and procedure 46a, which is similar to the mechanism and procedure 45a, on the system website for the advertiser to input or add advertisement-related video, i.e. video advertisements, to its pool of advertisement-related video on the system. A data checkpoint 46b, which is similar to the data checkpoint 45b, of the advertisement import module 46 operates to check whether a data file containing data pertaining to the advertisement-related video being inputted or added exists on the system. If not (N—No), the advertisement import module 46 provides a data input mechanism and procedure 46c, similar to mechanism and procedure 45c, for the advertiser to input the necessary data for the advertisement-related video. The type of data entered, which may include general data, metadata and any information needed for the advertisement-related video to be relevant and current, will ordinarily include information about the advertisement-related video and associated core assets, information about credits and/or rewards able to be earned by customers for viewing and/or interacting with the advertisement-related video, special offers, discounts, rebates, related video content and/or any information necessary to match the advertisement-related video to user preferences and/or placeholders. If the data checkpoint 46b finds that a data file pertaining to the advertisement-related video already exists (Y—Yes) on the system, a data file processing mechanism and procedure 46d, which is similar to the mechanism and procedure 45d, processes the data in the data file. A data sufficiency check 46e, similar to check 45e, determines whether or not the data file is complete and compatible with the data requirements for the advertisement-related video. If the check 46e determines that the data file is not sufficient (N—No), the advertiser is directed back to the data input mechanism and procedure 46c in order to enter the necessary data. Once all necessary data has been entered, the advertiser can review the completed advertisement video product via a review mechanism and procedure 46f and, if the advertisement-related video and associated data in the completed advertisement video product are satisfactory to the advertiser, the advertisement video product is accepted via an accept mechanism and procedure 46g. The accepted advertisement video product is then available on the system for inclusion in the play lists or video content of viewing programs, and may be made available by the system for use in connection with the mechanisms and procedures of the customer authoring module 34, the interactive components authoring module 36 and/or the provider authoring module 41.

The viewing system may further comprise a report module 47, further depicted in FIG. 4C, including a report mechanism 47a, to implement and carry out a set of processes by which video content providers, advertisers and other business partners can retrieve information on viewership and performance of video content.

Although the processes and procedures by which video content providers and advertisers interact with the viewing system could be done by human intervention, more typically the processes will be automated and implemented through customized scripting mechanisms, templates or other automation tools.

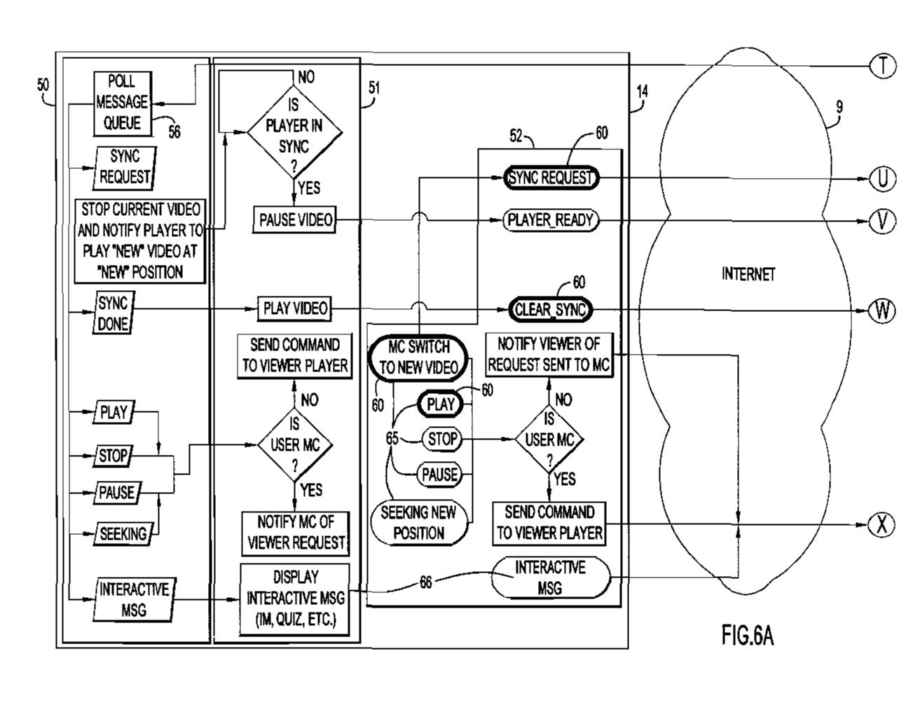

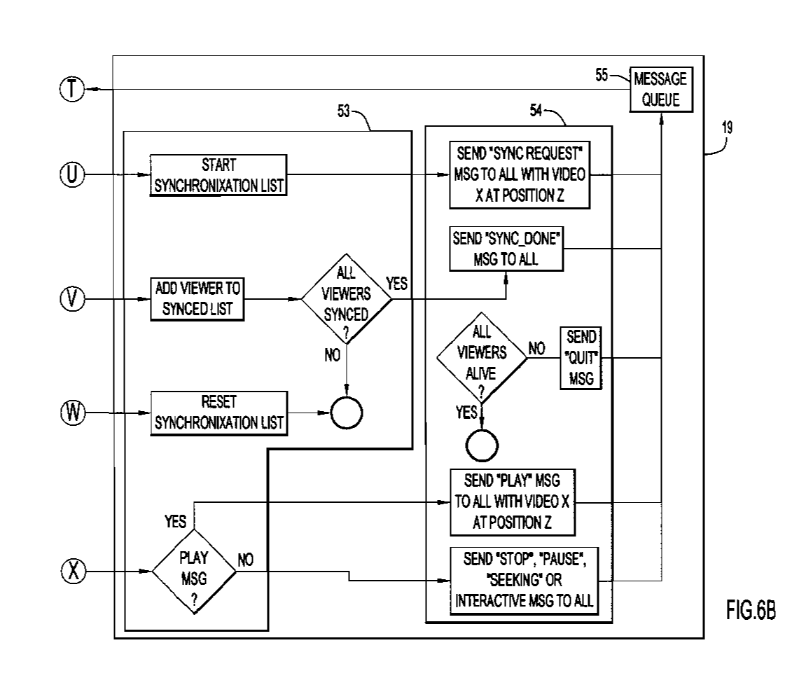

FIGS. 5A, 5B and 5C and FIGS. 6A and 6B illustrate the processes and associated programmatic messaging implemented by the viewing system when executing a shared viewing event. The set of processes and associated programmatic messaging 25e depicted in FIGS. 5A, 5B and 5C may be referred to as “background operations” and take place between one or more customer's or viewer's video player 14 (FIG. 5A), whether emcee or guest, and the system server 19 via the Internet 9 (FIG. 5B). The arrows and letters “D”, “E”, “F”, “G”, “H”, “I”, “J” and “K” in FIGS. 5A and 5B, and the arrows and letters “L”, “M”, “N”, “O”, “P”, “Q”, “R” and “S” in FIGS. 5B and 5C depict the interaction and relationship between the processes and messaging in the three drawing figures FIGS. 5A, 5B and 5C which together comprise the processes and messaging 25e. The processes and programmatic messaging 25e coordinate the overall system and messaging dispatch between all of the participants in a shared viewing event. On the video player side (FIG. 5A), the reception of messaging sent by the system server 19 on the system server side (FIG. 5C) is represented in column 50, the set of processes acting upon each specific message are represented in column 51, and the messaging sent by the video player's system module 15 to the system server 19 are represented in column 52. The messaging is acted on by a set of processes represented in column 53 on the system server 19 side (FIG. 5C), which in turn transmits appropriate messages back to the customer's video player 14 through a set of processes represented in column 54. Each customer's video player 14 has its own message queue 55 that is polled 56 at a regular short interval, typically a fraction of a second. Messages received by the customer's video player 14 are identified in FIG. 5A by rhomboid or slant-sided rectangular boxes as indicated at 57, the processes performed by the customer's video player 14 are identified in FIG. 5A by vertical-sided rectangular boxes as indicated at 58, and the messages sent from the customer's video player 14 back to the system server 19, resulting either from a programmatic output or from a customer action, are indicated in FIG. 5A by oblong or curve-sided rectangular boxes as indicated by 59. The messages coming exclusively from the video player 14 of the emcee are indicated in FIG. 5A by the boxes 60 outlined in bold. Most of the programmatic messaging takes place when customers join the viewing session as indicated at box 61, quit the viewing session as indicated at box 62, and when there is a need to synchronize the video players 14 of all customers participating in the shared viewing event to one another. Typically this need arises when, for example, a video item in the play list ends and the video players 14 of the participants automatically roll over to the next video item in the play list as indicated by box 63, or when the system server 19 polls the video players 14 and detects an off-sync situation as shown in box 64. It should be noted that a “quit” message 62 can also be sent if the user viewing system detects that the user Internet connection is failing.

FIGS. 6A and 6B depict processes and programmatic messaging implemented by the viewing system between one or more customer's or viewer's video player 14 (FIG. 6A), whether emcee or guest, and the system server 19 (FIG. 6B) via the Internet 9 (FIG. 6A), but in response to specific and explicit actions taken by the emcee and/or guests. The rhomboid or slant-sided rectangular boxes, the vertical-sided rectangular boxes, the oblong or curve-sided rectangular boxes, and the bold outlined boxes 60 have the same symbolism in FIGS. 6A and 6B as described above for FIGS. 5A-5C. The processes and programmatic messaging depicted in FIGS. 6A and 6B relate primarily to implementation of customer control over the viewing experience, including video item selection from the play list, play, stop, pause and seek actions or functions as indicated by boxes 65, and the interactive “people-oriented” messaging done between the customers themselves, including instant messaging, quizzes, etc., as indicated by boxes 66. Normally, the customer emcee controls the shared viewing event and experience for all of the customers in the shared viewing group. In the event that the customer emcee quits or loses connection with the Internet, the viewing system can be designed so that control over the viewing session and experience passes to one of the customer guests in the shared viewing group. Furthermore, the viewing system can be designed to allow the customer emcee to retain exclusive control over the shared viewing event and experience or to give all members of the shared viewing group control over the shared viewing event and experience.

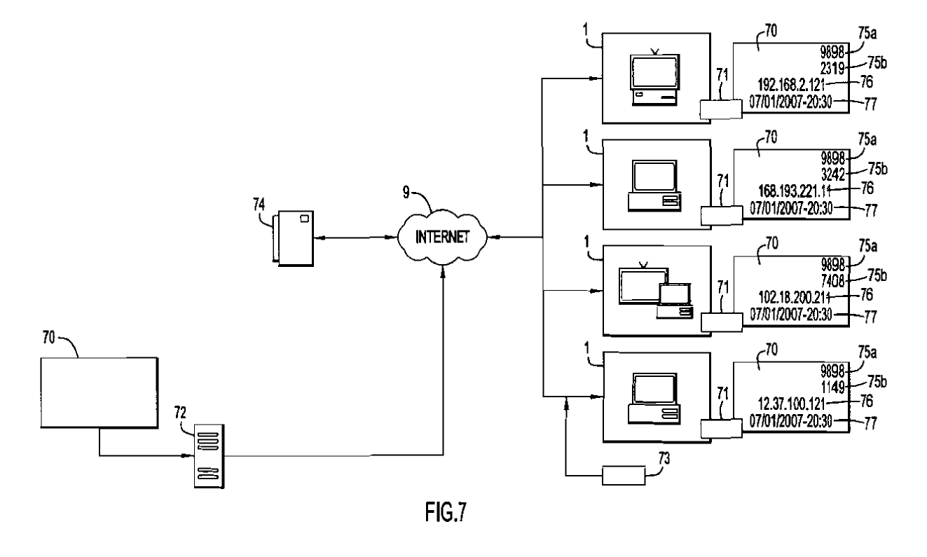

The viewing system further comprises a security feature to prevent, deter or protect against unauthorized use of video content on the system as illustrated in FIG. 7. The security feature, which may be called “License Tag”, encrypts a permanent invisible mark within the video content that is delivered to customers 1 through the viewing system and displayed on their video display screens. In the event that a customer or user would have unlawfully hacked and captured the video content, through a TV output interface for example, and would have posted it on an unauthorized distribution server, such as an FTP peers server, the permanent indelible mark would allow video content providers, including video content owners, to trace back to the unauthorized user and the time of unauthorized use. The security feature comprises a software module application 71 that operates on video content transmitted by the system and received by the viewing devices of the customers of the system. The software module application 71 can be carried out by the system modules 15 referred to above, or by separate modules specifically dedicated to the security feature and suitably connected to the customers' viewing devices. When video content 70 is transmitted via the system, whether delivered from a video server 72 or a local file or disk 73, for example a DVD, and is received by the video player associated with each customer's viewing devices, the application 71 embeds within the “video space” and at a regular interval, for example every 30 seconds, a visible and indelible mark that contains information about, and displayed either in a literal-readable or encrypted presentation form, a unique identifier 75a for the video content, the customer's user identification number 75b, the IP address 76 of the computer or other Internet-supported device used by the customer to receive and view video content from the system, and the date and time 77 at which the video content is displayed on the customer's viewing screen. The identifier 75a and the customer identification number 75b are provided by the system server 74. The IP address 76 and current date and time 77 are provided by the software module application 71. The security feature provides an innovative mode of copyright protection for real-time, fully Internet-based, streaming video delivery that will serve as a uniquely compelling and powerful tool for copyright owners.

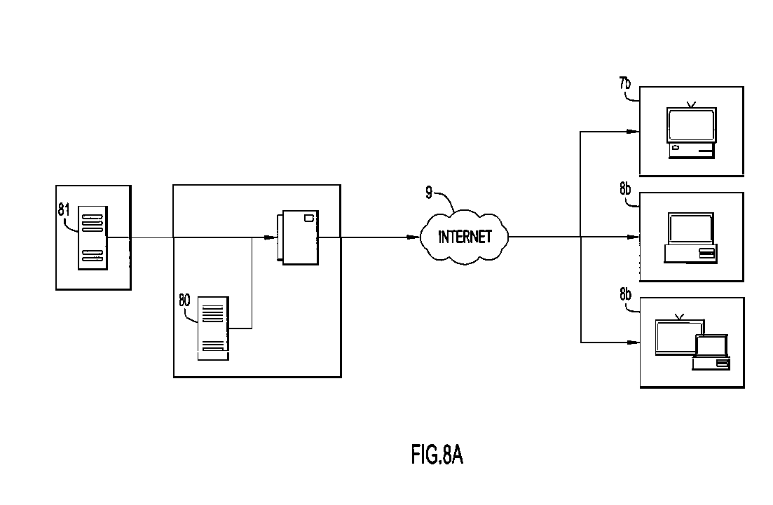

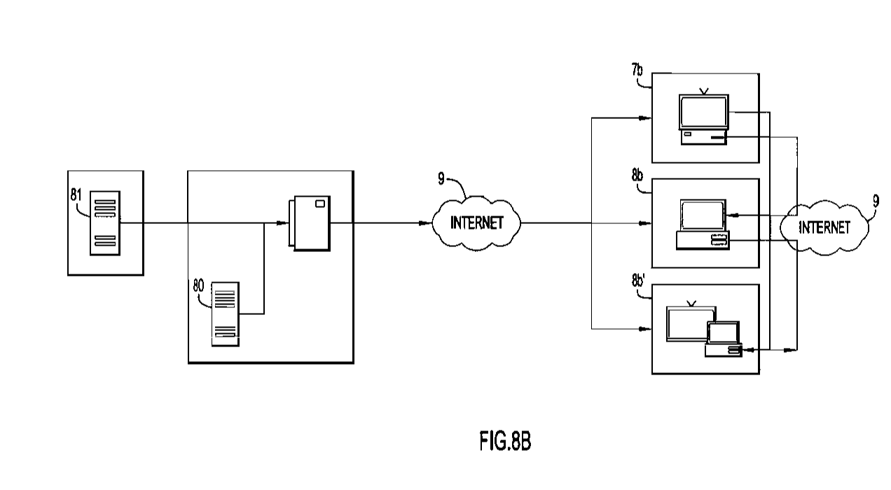

The viewing system may be implemented using various mechanisms and methodologies of Internet video delivery to deliver the video content via the Internet 9 to customers/users. FIG. 8A represents implementation of the viewing system using a method of Internet video delivery involving a streaming video server, which can be a streaming video server 80 within the viewing system's own domain (like system video server 19 in FIG. 1, for example) or a third-party or outside streaming video server or location 81 (like video servers 20 and 21 in FIG. 1, for example). In either case, the delivery method involves streaming the video content from the video server, via the Internet 9, to the viewing devices of each and all customers/users, 7b, 8b, 8b for example, requesting the video content.

FIG. 8B represents implementation of the viewing system using an alternative method of Internet video delivery involving an emerging technology called “Peer-to-Peer”, also referred to as “P2P”. This method provides a variety of delivery mechanisms and paths, with real-time dynamic capabilities for swapping or interchanging between the various mechanisms or paths, typically depending on the overall Internet congestion status and an ongoing search for the best possible delivery mechanism or path. As an example, a customer/user 7b could receive the video content entirely from a video server 80 or 81 as described above in connection with FIG. 8A, while another customer/user 8b could receive the video content in part from the originating video server 80 or 81 and in part through a parallel connection to the “peer” customer/user 7b. Accordingly, the user 8b could tap partly from the originating video server and be partly serviced through the parallel “peer” connection. Yet another customer/user 8b′ could be serviced or receive the video content entirely or exclusively through “peer” connection(s) with customer/user 7b and/or 8b.

The role of asset placeholders in the viewing system can be better understood with reference to FIGS. 9A and 9B. FIG. 9A shows a play list 85 for a viewing session authored by User X on a particular date and containing a main feature 82, an interactive component 83 in the form of a game, and two placeholders 84a and 84b. The placeholders 84a and 84b are positioned in the play list by User X at the time of authoring the play list. As explained above, the author, User X, can be a customer/author or a provider/author. The type of placeholders that are available to customer authors are promotion placeholders and user preference advertisement placeholders. The types of placeholders available to provider authors are promotion placeholders, user preference advertisement placeholders and provider advertisement placeholders. The provider advertisement placeholders are employed in the provider authoring module 41 as described above. Promotion placeholders are bound to a main feature video and they assign linking rules based on characteristics of the main feature such as genre, date of release, other factors, provider of the main feature and provider rules for priorities established by the provider. Once the play list 85 has been authored by User X, it essentially remains permanently in the viewing system database. At a later time, when a customer views the play list 85 in a viewing session, the placeholders 84a and 84b are dynamically switched or replaced with a relevant linking video asset right before the customer begins viewing the viewing session. The dynamic placeholder-to-video switching operates under pre-established business rules of viewing system and, in particular, the linking rules by which the video assets selected by the system to replace the placeholders are relevant to the type and characteristics of the placeholder and/or the customer. For example, if the main feature 82 in the play list 85 of FIG. 9A is a drama genre and originates from provider ABCD, the switching process will enforce linking rules that match the latter characteristics to a particular video asset to be switched for the new release placeholder 84a. In the case of the user preference advertisement placeholder 84b, the linking rules will replace the placeholder 84b with a video advertisement relevant to the viewing customer's advertisement preferences. The play list 85 of video content actually transmitted at a later time to viewing customers, i.e. User Y and User Z, after dynamic switching is shown in FIG. 9B. FIG. 9B shows that User Y and User Z both receive the main feature 82 and the interactive component 83 from the original play list. Both User Y and User Z receive the same new release promotion 86, i.e. “Now Available on DVD”, pertaining to a main feature DVD just released on the buying market. The new release promotion 86 has been positioned in place of the placeholder 84a under the dynamic switching process and, under the linking rules, has been selected for its relevance to the genre and provider of the main feature 82. With respect to the user preference advertisement placeholder 84b, however, the switching process has operated to replace the placeholder 84b in User Y's play list with a video car advertisement 87a and has replaced the placeholder 84b in User Z's play list with a travel advertisement 87b which are linked to the user advertisement preferences entered into the system by Users Y and Z. As pointed out above, users are able to enter and modify user preferences through the account set-up process, and the system may be designed to provide customers with a “My Settings”-type web page for this purpose.

As already mentioned above, one type of interactive component that may be incorporated in the video content of viewing sessions authored in the viewing system is closed captioning. Essentially, closed captioning is conventionally known as a text version of the spoken part of an audio-video presentation that usually appears at the lower part of the viewing screen. The viewing system of the present invention is designed to operate by offering each individual viewer closed captioning in the language appropriate for the individual viewer. The user preference setting or “My Settings”-type web page will ask that the customer enter the customer's preferred language and, in addition, may ask the customer to indicate any secondary language known to the customer. The dedicated system equipment or software application on the customer's video player-side of the system picks up the language profiling information entered by the customer and automatically offers the customer, if needed, the appropriate closed captioning version for the video content that the customer views through the viewing system. Accordingly, members of a shared viewing group can receive closed captioning in different languages on their viewing screens even as they watch the same original video.

Language appropriate closed captioning can also be incorporated into the video content of viewing programs through the interactive components authoring module 36. Most feature videos are made available with two, and sometimes more, language versions of closed captioning. In order to expand the number of language versions of closed captioning beyond that provided by the source of the original video, the interactive components authoring module 36 can be used by users of the viewing system who have translation skills to produce additional language versions of closed captioning in languages not originally provided by the original video source. The business rules of the system can be designed so that users who serve as translators will be remunerated appropriately, such as on a per-usage basis of the closed captioning by other customers of the system. Under the business rules of the system, video content providers and/or owners will have the ability to veto customer/translated closed captioning translated or produced by customers. In addition, poorly translated closed captioning would inherently be filtered out of the viewing system through the ratings, review and comments provided by the customers of the viewing system.

Inasmuch as the present invention is subject to many variations, modifications and changes in detail, it is intended that all subject matter discussed above or shown in the accompanying drawings be interpreted as illustrative only and not be taken in a limiting sense.

What is claimed is:

1. An Internet-based viewing system for interactive synchronized shared viewing of video content, comprising
a viewing system website accessible to viewing customers of said viewing system via the Internet;
a viewing session selection mechanism accessible to the customers of said viewing system on said website for selecting viewing sessions for transmission by said viewing system to the customers via the Internet, said viewing session selection mechanism including a customer authoring module providing a mechanism on said website for customers to author customized viewing sessions, wherein a customized viewing program includes a play list of video items selected by the customer, said customer authoring module providing a mechanism on said website for customers to include one or more advertisements among the video items in the play lists for customized viewing programs, and a mechanism on said website for customers to include one or more interactive components among the video items in the play lists for customized viewing programs;
a schedule module providing a mechanism on said website for customers to schedule a date and time for transmission by said viewing system of selected viewing sessions, and providing a mechanism on said website for customers to optionally elect to make the selected viewing sessions publicly available on said website to all customers of said viewing system;
an invitation module providing a mechanism on said website for customers to optionally invite one or more specific other customers of said viewing system to view a selected viewing session in synchrony as a shared viewing group, said viewing system operating to automatically transmit electronically an invitation to the specific other customers invited to participate in the shared viewing group;
a notification reply module providing a mechanism on said website for customers to accept or decline invitations to participate in shared viewing groups;
a payment module providing a mechanism on said website for customers to electronically pay a fee for viewing sessions transmitted by said viewing system that the customer has elected to receive;
means for transmitting viewing sessions via the Internet at the scheduled date and time to customers who have paid the fee for the viewing sessions; and
means for synchronizing transmission of viewing sessions among the customers in shared viewing groups while enabling interactive communication between the customers within in the shared viewing groups via the Internet.

2. The Internet-based viewing system recited in claim 1 wherein said customer authoring module provides a mechanism on said website for customers to search for and select main feature video items, including movies and main feature programs, for inclusion in the play lists of customized viewing programs.

3. The Internet-based viewing system recited in claim 2 wherein said customer authoring module provides a mechanism on said website for customers to search for and select advertisements for inclusion in the play lists of customized viewing programs.

4. The Internet-based viewing system recited in claim 1 wherein said viewing system further includes an interactive components authoring module providing a mechanism on said website for customers to create interactive components for inclusion in the play lists of customized viewing programs.

5. The Internet-based viewing system recited in claim 1 wherein said viewing system further includes a business rules management module that assigns pre-established rewards to customers in exchange for one or more actions taken by customers, wherein said actions include viewing advertisements and interacting with advertisements in the play lists of viewing programs.

6. The Internet-based viewing system recited in claim 5 wherein said payment module provides a mechanism on said website for customers to redeem said rewards toward payment of the fee for viewing sessions.

7. The Internet-based viewing system recited in claim 1 wherein said customer authoring module provides a mechanism on said website for customers to insert one or more placeholders in the play lists of customized viewing programs and said viewing system dynamically replaces each of said placeholders with a relevant video item just prior to transmitting the viewing sessions.

8. The Internet-based viewing system recited in claim 1 wherein said viewing system further includes a security mechanism that encrypts a permanent invisible mark within the video content that is transmitted to the customers of said viewing system, said mark being unique for each customer of said viewing system and being traceable back to the customer and to the date and time that the video content is received by the customer.

9. An Internet-based viewing system for interactive synchronized shared viewing of video content, comprising
a viewing system website accessible via the Internet to viewing customers of said viewing system and to providers of video content to said viewing system;
a viewing session selection mechanism accessible to the customers of said viewing system on said website for selecting viewing sessions for transmission by said viewing system to the customers via the Internet, said viewing session selection mechanism including a pre-packaged viewing program module providing a mechanism on said website for customers to search for and select pre-packaged viewing programs from a pool of pre-packaged viewing programs, wherein said pre-packaged viewing programs each include a play list of video items pre-selected by a provider of video content;
a provider authoring module accessible to the providers of video content on said viewing system website and providing a mechanism on said website for providers of video content to author said pre-packaged viewing programs by selecting the video items to be included in the play lists for said pre-packaged viewing programs, said provider authoring module including a mechanism on said website for providers of video content to include one or more advertisements among the video items in the play lists for pre-packaged viewing programs;
a schedule module providing a mechanism on said website for customers to schedule a date and time for transmission by said viewing system of selected viewing sessions and providing a mechanism on said website for customers to optionally elect to make the selected viewing sessions publicly available on said website to all customers of said viewing system;
an invitation module providing a mechanism on said website for customers to optionally invite one or more specific other customers of said viewing system to view a selected viewing session in synchrony as a shared viewing group, said viewing system operating to automatically transmit electronically an invitation to the specific other customers invited to participate in the shared viewing group;
a notification reply module providing a mechanism on said website for customers to accept or decline invitations to participate in shared viewing groups;
a payment module providing a mechanism on said website for customers to electronically pay a fee for viewing sessions transmitted by said viewing system that the customer has elected to receive;
means for transmitting viewing sessions via the Internet at the scheduled date and time to customers who have paid the fee for the viewing sessions; and
means for synchronizing transmission of viewing sessions among the customers in shared viewing groups while enabling interactive communication between the customers within the shared viewing groups via the Internet.

10. The Internet-based viewing system recited in claim 9 wherein said provider authoring module provides a mechanism on said website for providers of video content to search for and select main feature video items, including movies and main feature programs, for inclusion in the play lists of pre-packaged viewing programs.

11. The Internet-based viewing system recited in claim 10 wherein said viewing system further includes a sponsor selection mechanism on said website for providers of video content to search for and select sponsors for viewing programs, wherein selection of a sponsor for a viewing program results in inclusion of a sponsor advertisement in the play list for the viewing program.

12. The Internet-based viewing system recited in claim 9 wherein said provider authoring module provides a mechanism on said website for providers of video content to insert one or more placeholders in the play lists of a pre-packaged viewing programs and said viewing system dynamically replaces each of said placeholders with a relevant video item just prior to transmitting the viewing sessions.

13. The Internet-based viewing system recited in claim 12 wherein said viewing system further includes an import module accessible on said website to providers of video content and providing a mechanism for importing video content and associated data into said viewing system on an ongoing basis, and said viewing system dynamically replaces each of said placeholders with the most recently imported relevant video items.

14. An Internet-based viewing system for interactive synchronized shared viewing of video content, comprising
a viewing system website accessible via the Internet to viewing customers of said viewing system and to providers of video content to said viewing system;
a mechanism for customers on said website to enter into said viewing system personal advertisement preferences for the customer;
a viewing session selection mechanism accessible to the customers of said viewing system on said website for selecting viewing sessions for transmission by said viewing system to the customers via the Internet, said viewing session selection mechanism including a pre-packaged viewing program module providing a mechanism on said website for customers to optionally search for and select pre-packaged viewing programs from a pool of pre-packaged viewing programs, wherein said pre-packaged viewing programs each include a play list of video items pre-selected by a provider of video content;
a provider authoring module accessible to the providers of video content on said website and providing a mechanism on said website for providers of video content to author said pre-packaged viewing programs by selecting the video items to be included in the play lists for said pre-packaged viewing programs, said provider authoring module including a mechanism on said website for providers of video content to insert one or more placeholders in the play lists for said pre-packaged viewing programs;
a customer authoring module accessible to customers on said website and providing a mechanism on said website for customers to optionally author customized viewing programs by selecting the video items to be included in the play lists for the customized viewing programs, said customer authoring module including a mechanism on said website for customers to insert one or more placeholders in the play lists for the customized viewing programs;
a schedule module providing a mechanism on said website for customers to schedule a date and time for transmission by said viewing system of selected viewing sessions, and providing a mechanism on said website for customers to optionally elect to make the selected viewing sessions publicly available on said website to all customers of said viewing system;
an invitation module providing a mechanism on said website for customers to optionally invite one or more specific other customers of said viewing system to view a selected viewing session in synchrony as a shared viewing group, said viewing system operating to automatically transmit electronically an invitation to the specific other customer to participate in the shared viewing group;
a notification reply module providing a mechanism on said website for customers to accept or decline invitations to participate in shared viewing groups;
a payment module providing a mechanism on said website for customers to electronically pay a fee for viewing sessions transmitted by said viewing system that the customer has elected to receive;
means for transmitting viewing sessions via the Internet at the scheduled date and time to customers who have paid the fee for the viewing sessions wherein, at the time of transmission, said viewing system dynamically replaces each of said placeholders with a relevant video item; and
means for synchronizing transmission of viewing sessions among the customers in shared viewing groups while enabling interactive communication between the customers within the shared viewing groups via the Internet.

15. The Internet-based viewing system recited in claim 14 wherein said placeholders available to providers of video content for insertion in the play lists for pre-packaged viewing programs include promotional placeholders associated with main feature video items, customer preference advertisement placeholders, and provider advertisement placeholders, said viewing system further includes an import module accessible on said website to providers of video content and providing a mechanism on said website for providers to import video items and associated data into said viewing system on an ongoing basis including video items corresponding to said promotional placeholders and to said provider advertisement placeholders, wherein said viewing system dynamically replaces said promotional placeholders and said provider advertisement placeholders with the most recently imported relevant video items corresponding to said placeholders.

16. The Internet-based viewing system recited in claim 15 wherein said viewing system dynamically replaces, for a given customer, said customer preference advertisement placeholders with a video advertisement relevant to the personal advertisement preferences entered by the customer into said viewing system.

17. The Internet-based viewing system recited in claim 16 wherein said viewing system further includes an advertisement import module accessible on said system website to advertisers and providing a mechanism on said website for advertisers to import video advertisement items and associated data into said viewing system on an ongoing basis corresponding to said customer preference advertisement placeholders, wherein said viewing system dynamically replaces said customer preference advertisement placeholders with the most recently imported relevant video advertisement items corresponding to said customer preference advertisement placeholders.

18. The Internet-based viewing system recited in claim 17 wherein said viewing system operates to assign a reward to customers who author customized viewing programs having play lists with one or more placeholders.

19. The Internet-based viewing system recited in claim 14 wherein said viewing system operates to assign a reward to customers who elect to make a selected viewing program publicly available on said website whenever another customer of said viewing system selects and views the viewing program.

20. The Internet-based viewing system recited in claim 14 wherein said customer authoring module provides a mechanism on said website for customers to search for and select main feature video items having sponsors associated therewith, and said viewing system operates to present sponsor advertisements to the customers for inclusion in the play lists of customized viewing programs, and said website provides a mechanism for customers to accept or not accept the sponsor advertisements for inclusion in the play lists of customized viewing programs.
